(19) United States
(12) Patent Application Publication
(10) Pub. No.: US 2016/0011916 A1
(43) Pub. Date: Jan. 14, 2016

(54) COMPUTER, ASSOCIATION CALCULATION METHOD, AND STORAGE MEDIUM

(71) Applicant: HITACHI, LTD., Chiyoda-ku, Tokyo (JP)

(72) Inventors: Yuji YAGI, Tokyo (JP); Kimitaka TAMURA, Tokyo (JP)

(21) Appl. No.: 14/770,618

(22) PCT Filed: May 28, 2013
(86) PCT No.: PCT/JP2013/064709

§ 371 Date: Aug. 26, 2015

(51) Int. Cl. G06F 9/52

(52) U.S. Cl. CPC G06F 9/52

(57) ABSTRACT

A computer is provided with a control unit, including a processor, and a storage unit for storing pieces of data that were used by a plurality of businesses, and calculates the association between the plurality of businesses, wherein: the storage unit stores data identification information identifying the pieces of data that were used by the plurality of businesses, business identification information identifying each of the plurality of businesses, and association information identifying the association between the business identification information and the data identification information about the pieces of data used by the plurality of businesses; and the control unit checks the association information and outputs, as a combination of associated sets of business identification information, different sets of business identification information which are associated with at least one same piece of data among the pieces of data used by the plurality of businesses and identified by the data identification information.

### BACKGROUND

This invention relates to a computer system configured to calculate relevance between different tasks.

In recent years, there has been an increasing interest in use of big data. Data assumed as the big data includes control-system data, such as data of a sensor device, in addition to conventional information-system data, such as data of a POS terminal and transaction data. There is an increasing need to create new and valuable information from those types of information and provide the created information.

Examples of a new value obtained by using the big data include calculation of relevance between various different tasks through the use of the information-system data or the control-system data.

There is known, for example, JP 2009-252057 A as a technology relating to relevance between tasks. In JP 2009-252057 A, a design procedure is stored in a computer as a template, and knowledge information is described in association with the template. Further, when newly creating or updating a template, the computer presents a difference or dependence relationship between the stored templates based on the associated knowledge information.

### SUMMARY

As described above, when the relevance between different tasks is extracted as a new value and the relevance between the tasks is used, for example, through presentation of details of improvement in a specific task acquired in the specific task to another task relevant to the specific task, improvement in the other task can be expected.

Incidentally, what is important in the calculation of the relevance between tasks is that the relevance needs to be acquired automatically by a computer. This is because the types and amount of the information-system data or the control-system data have become enormous in recent years, and thus it becomes increasingly difficult to process such an enormous amount of data through manual work.

However, with the related art such as JP 2009-252057 A, there has been a problem in that because the template and the knowledge information are associated with each other through manual work, a significant amount of time and effort is required to calculate the relevance between different tasks.

A representative aspect of this invention is as follows. A computer, comprising: a control unit comprising a processor; and a storage unit configured to store data used by a plurality of tasks, the computer being configured to calculate relevance between the plurality of tasks, the storage unit being configured to hold: data specifying information for specifying data used by the plurality of tasks; task specifying information for specifying each of the plurality of tasks; and association information for storing an association between the data specifying information to be used by each of the plurality of tasks and the task specifying information, the control unit being configured to refer to the association information to output, as a combination of relevant pieces of task specifying information, different pieces of task specifying information that are associated with pieces of data specifying information specifying the data to be used by each of the plurality of tasks, at least one of the pieces of data specifying information being the same in the different pieces of task specifying information.

According to the one embodiment of this invention, through comparison of pieces of data specifying information processed in respective tasks from among an enormous amount of data, it is possible to calculate the relevance between different tasks. As a result, details of improvement in a specific task acquired in the specific task can be presented to another task relevant to the specific task, and hence the improvement in the other task can be expected.

### BRIEF DESCRIPTION OF THE DRAWINGS

FIG. 1 is an illustration of a first embodiment of this invention, and is a block diagram for illustrating an example of a computer system.

FIG. 2 is a diagram for showing an example of the data storage table according to the first embodiment of this invention.

FIG. 3 is a diagram for showing an example of the flow information table for the failure prevention task according to the first embodiment of this invention.

FIG. 4 is a diagram for showing an example of the flow information table for the part sales promotion task according to the first embodiment of this invention.

FIG. 5 is a diagram for showing an example of the flow information table for the report generation task according to the first embodiment of this invention.

FIG. 6 is a diagram for showing an example of the relevant information management table according to the first embodiment of this invention.

FIG. 7 is a diagram for showing an example of the work information management table according to the first embodiment of this invention.

FIG. 8 is an illustration of screen image to be displayed on the display according to the first embodiment of this invention.

FIG. 9 is an illustration of screen image to be displayed on the display according to the first embodiment of this invention.

FIG. 10 is an illustration of screen image to be displayed on the display according to the first embodiment of this invention.

FIG. 11 is an illustration of screen image to be displayed on the display according to the first embodiment of this invention.

FIG. 12 is a flowchart for illustrating an example of processing to be executed by the task processing modules of the task client according to the first embodiment of this invention.

FIG. 13 is a flowchart for illustrating an example of processing to be executed by the screen display module in Step S4 of FIG. 12 according to the first embodiment of this invention.

FIG. 14 is a diagram for showing an example of the work information management table obtained by adding a new record according to the first embodiment of this invention.

FIG. 15 is a flowchart for illustrating an example of processing to be executed by the relevant information processing module according to the first embodiment of this invention.

FIG. 16 is a flowchart for illustrating an example of processing to be executed by the relevant information processing module according to the first embodiment of this invention.

FIG. 17 is a flowchart for illustrating an example of processing to be executed by the relevance calculation module according to the first embodiment of this invention.

FIG. 18 is the relevant information management table according to the first embodiment of this invention.

FIG. 19 is a diagram for showing an example of the relevance table according to the first embodiment of this invention.

FIG. 20 is a diagram for showing an example of the flow information table F100 for the failure prevention task after the processing of the relevant information processing module according to the first embodiment of this invention.

FIG. 21 is a diagram for showing an example of the flow information table F300 for the report generation task after the processing of the relevant information processing module according to the first embodiment of this invention.

FIG. 22 is a flowchart for illustrating an example of processing to be executed by the data delivery processing module according to the first embodiment of this invention.

FIG. 23A is a block diagram for illustrating an example of a configuration of the data collection/delivery server according to a second embodiment of this invention.

FIG. 23B is a flowchart for illustrating an example of processing to be executed by the relevant information processing module according to the second embodiment of this invention.

FIG. 24 is a diagram for showing an example of the use count table according to the second embodiment of this invention.

FIG. 25 is a flowchart for illustrating an example of processing to be executed by the relevant information processing module according to a third embodiment of this invention.

FIG. 26 is a flowchart for illustrating an example of processing to be executed by the screen display module of the task client according to the third embodiment of this invention.

FIG. 27 is an image for illustrating an example of a screen to be output on the input/output apparatus of the task client according to the third embodiment of this invention.

FIG. 28 is a flowchart for illustrating an example of processing to be executed by the relevant information processing module according to a fourth embodiment of this invention.

FIG. 29 is a flowchart for illustrating an example of processing to be executed by the relevance calculation module according to the fourth embodiment of this invention.

FIG. 30 is a diagram for showing examples of the relevance table according to the fourth embodiment of this invention.

FIG. 31 is a diagram for showing examples of the relevance table according to the fourth embodiment of this invention.

FIG. 32A is a flowchart illustrating an example of a first part of processing to be executed by the relevance calculation module according to a fifth embodiment of this invention.

FIG. 32B is a flowchart illustrating an example of a last part of processing to be executed by the relevance calculation module according to a fifth embodiment of this invention.

FIG. 33 is a diagram for showing examples of the relevance table according to the fifth embodiment of this invention.

FIG. 34 is a diagram for showing examples of the relevance table according to the fifth embodiment of this invention.

### DETAILED DESCRIPTION OF THE PREFERRED EMBODIMENTS

A description is made below of an embodiment of this invention with reference to the accompanying drawings.

### First Embodiment

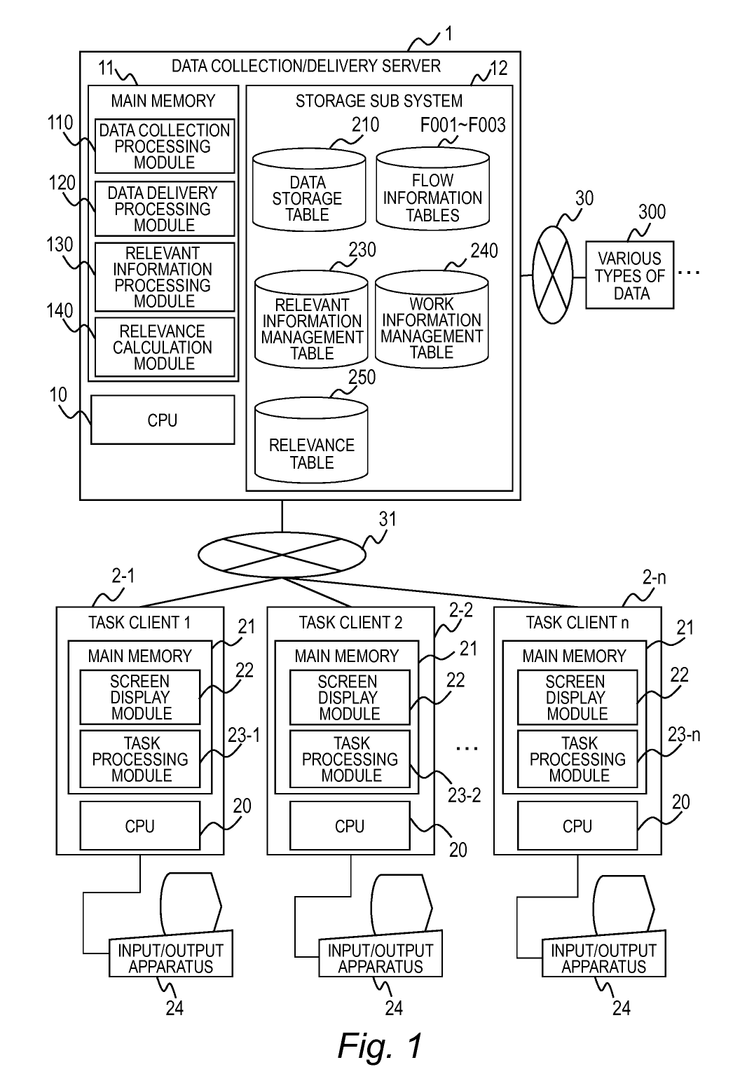

FIG. 1 is an illustration of a first embodiment of this invention, and is a block diagram for illustrating an example of a computer system. A data collection/delivery server 1 is a computer including a CPU 10 configured to execute arithmetic processing, a main memory 11 configured to hold a program and data, an storage sub system 12 configured to store a program and data, and a network interface (not shown). The data collection/delivery server 1 is coupled to networks 30 and 31 via a network interface (not shown).

A sensor, a computer, or an apparatus, which is not shown, is coupled to the network 30. The sensor, the computer, or the apparatus transmits various types of data 300 to the data collection/delivery server 1. The data collection/delivery server 1 collects the various types of data 300 from the network 30 and stores the collected data in the storage sub system 12.

Task clients 2-1 to 2-n serving as computers configured to execute various tasks are coupled to the network 31. The data collection/delivery server 1 transmits the collected various types of data 300 in response to requests from the task clients 2-1 to 2-n. The various types of data 300 are formed of various types of information including sensor information, image information, document information such as a report, and the like.

Various tasks are executed in the task clients 2-1 to 2-n. Examples of the various tasks include a failure prevention task in which the sensor information or the image information is input to monitor a failure of an apparatus, a part sales promotion task in which the sensor information is input to plan replacement of a part of an apparatus, and a report generation task in which the sensor information and the image information are input to generate a report of a state of the apparatus. It should be noted that in the following, the task clients 2-1 to 2-n are collectively referred to as “task clients 2”.

The data collection/delivery server 1 stores, in the main memory 11, a data collection processing module 110, a data delivery processing module 120, a relevant information processing module 130, and a relevance calculation module 140, which are executed by the CPU 10.

The data collection/delivery server 1 stores, in the storage sub system 12, a data storage table 210, flow information tables F001 to F003, a relevant information management table 230, a work information management table 240, and a relevance table 250. It should be noted that F001 to F003 are each a piece of information for specifying a task, and are each a piece of task specifying information to be described later.

The data collection processing module 110 collects the various types of data 300 from the network 30, and stores the collected data in the data storage table 210.

In response to the request from the task client 2, the data delivery processing module 120 refers to the flow information tables F001 to F003 (described later) for a corresponding task, and delivers data to be processed by the task client 2.

The relevant information processing module 130 executes processing of referring to the relevance table 250 to be described later to determine whether or not to present new data processed in one task to another task when the new data is processed in the one task.

The relevance calculation module 140 refers to the data storage table 210 and the flow information tables F001 to F003 to calculate relevance between the tasks.

The function modules including the data collection processing module 110, the data delivery processing module 120, the relevant information processing module 130, and the relevance calculation module 140 are loaded onto the main memory 11 as programs.

The CPU 10 executes processing in accordance with the program of each function module, to thereby operate as a function unit configured to implement a predetermined function. For example, the CPU 10 executes processing in accordance with a data collection program, to thereby function as the data collection processing module 110. The same applies to other programs. Further, the CPU 10 also operates as function units (or control units) configured to implement a plurality of processes executed by the respective programs. The computer and the computer system are an apparatus and a system that include those function units (or control units).

It should be noted that the data delivery processing module 120 functions as the data delivery processing module when the CPU 10 executes a data delivery program, the relevant information processing module 130 functions as the relevant information processing module when the CPU 10 executes a relevant information program, and the relevance calculation module 140 functions as the relevance calculation module when the CPU 10 executes a relevance calculation program. It should be noted that the same applies to other function components, and in the following description, even when the function component is the subject of a sentence, an execution entity of processing is the CPU 10 (or control unit).

The programs for implementing the respective functions of the data collection/delivery server 1 and the information such as the tables can be stored in the storage sub system 12, a non-volatile semiconductor memory, a storage device such as a non-volatile semiconductor memory, a hard disk drive, or a solid state drive (SSD), or a computer-readable, non-transitory data storage medium such as an IC card, an SD card, or a DVD.

The task clients 2-1 to 2-n are each a computer including a CPU 20, a main memory 21, an input/output apparatus 24, and a network interface (not shown). In the main memory 21, a screen display module 22 and one of task processing modules 23-1 to 23-n are stored, which are executed by the CPU 20.

The tasks to be executed in the task processing modules 23-1 to 23-n include the failure prevention task, the part sales promotion task, the report generation task, and the like. It should be noted that in the following description, the task processing modules 23-1 to 23-n are collectively referred to as “task processing modules 23”. The task processing module 23 to be executed by each of the task clients 2 can be selected by a user of each of the task clients. The input/output apparatus 24 includes an input apparatus (or input unit) such as a keyboard or a mouse and an output apparatus (or output unit) such as a display. The task processing module 23 records work information when executing a task, and after finishing the task, transmits the work information to the data collection/delivery server 1.

The screen display module 22 receives the flow information tables F001 to F003 from the data collection/delivery server 1, and outputs the received flow information tables F001 to F003 to the display of the input/output apparatus 24 or the like connected to the task client 2.

It should be noted that the task processing modules 23 functions when the CPU 20 executes a task program, and the screen display module 22 functions when the CPU 20 executes a screen display program.

It should be noted that in such a mode in which the task client 2 uses a web browser (not shown) to couple to the data collection/delivery server 1 and executes the task on the web browser, processing corresponding to the task processing module may be arranged in the data collection/delivery server 1.

An outline of this embodiment is as follows. The computer system including the data collection/delivery server 1 and the task client 2 executes, for example, a maintenance task for a gas turbine of a thermal power station.

The maintenance task for the gas turbine includes the failure prevention task, the part sales promotion task, and the report generation task. In the failure prevention task to be executed by each task client 2, data of sensor information, a facility photograph, and a gas turbine drawing are used. In the part sales promotion task, data of the sensor information is used. In the report generation task, data of the sensor information, the facility photograph, and the gas turbine drawing are used. When one of the tasks is to be executed, the data collection/delivery server 1 selects data to be used in the one task from the data storage table 210, and delivers the selected data to the task client 2 that is to execute the one task.

It is now assumed that the quality of work has been improved through the use of an inspection report in the failure prevention task. On this assumption, when the knowledge “use of the inspection report” is to be fed back automatically to another task, an issue is to determine a specific task to which this knowledge is to be fed back. In view of this, in this invention, the relevance between the tasks is found based on information on specific data (sensor information, facility photograph, or gas turbine drawing) being used by each of the tasks. In the case of this embodiment, based on the fact that the failure prevention task and the report generation task use the sensor information, the facility photograph, and the gas turbine drawing, it is determined that those tasks are relevant to each other. As a result, it is possible to feed back this knowledge (use of the inspection report) to a worker who is to execute the report generation task.

It should be noted that the task to be executed in the task client 2 is not limited to the gas turbine maintenance task, and the data collection/delivery server 1 is applicable to a computer system configured to deliver the collected various types of data 300 to the task clients 2 in which various types of tasks are executed.

The various types of data 300 can include data of a social networking service (SNS) and the like in addition to the transaction data and the sensor information. With this, data processed in different tasks are compared with each other so as to calculate the relevance between the tasks. Thus, for highly relevant tasks, it is possible to propose data and processing used and executed in only one of the tasks to the other task.

Next, a description is given of the respective tables stored in the storage sub system 12.

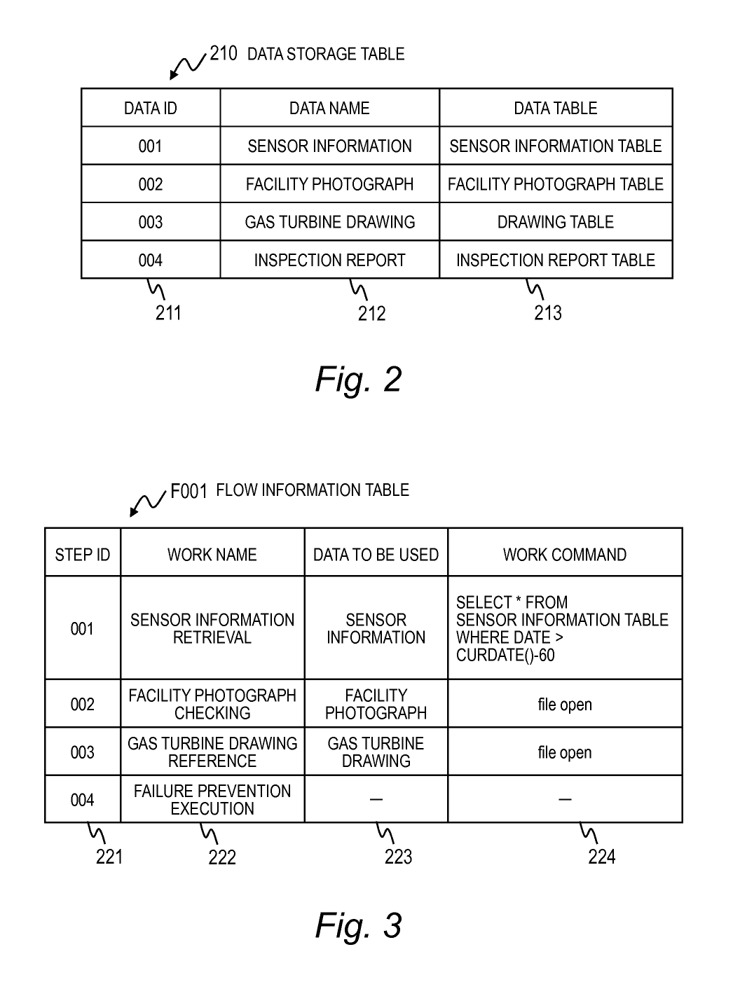

FIG. 2 is a diagram for showing an example of the data storage table 210. The data storage table 210 includes, in one record (or entry), a data ID 211 for storing an identifier of data among the various types of data 300, a data name (data specifying information) 212 for storing the name of data, and a data table 213 for storing the name of a table for accumulating the substance of data. The data ID 211 only needs to be an identifier that is unique within the computer system. Further, the data table 213 may also be a pointer to the table for storing the substance of the various types of data 300. Further, although an example is described in which information is stored in a table in this embodiment, information only needs to be stored in a storage area such as an array, and a data format is not limited to a table. Therefore, the data storage table 210 may be a data storage area or a data storage module, and the same applies to other tables to be described below.

Further, although an example is described in which the data storage table 210 is stored in the storage sub system 12 in this embodiment, a part or all of the data storage table 210 may be stored in the main memory 11. In other words, the data storage table 210 only needs to be stored in a storage apparatus (or a storage unit) obtained by seeing the main memory 11 and the storage sub system 12 as a whole, and a storage destination of the data storage table 210 is not limited to the main memory 11 or the storage sub system 12. It should be noted that the same applies to the other tables to be described below.

Further, although an example is described in which the data storage table 210 is stored in the data collection/delivery server 1 in this embodiment, the data storage table 210 may be stored in another computer or storage apparatus, and the storage destination of the data storage table 210 is not limited to a local storage apparatus of the computer. It should be noted that the same applies to the other tables to be described below.

FIG. 3 is a diagram for showing an example of the flow information table (F001) for the failure prevention task. The flow information tables F001 to F003 shown in FIG. 3 to FIG. 5 are tables for storing a procedure (steps) and details of work for each task.

The flow information table F001 for the failure prevention task includes, in one record (or entry), a step ID 221 for storing a position in the order of a task flow, a work name 222 for storing the name of work corresponding to the step ID 221, data to be used (data specifying information) 223 for storing data to be used in the step ID 221, and a work command 224 for storing a command (e.g., query) to be used in the step ID 221. Alternatively, the data to be used 223 may be a pointer to a storage destination of the substance of data.

In the flow information table (F001) for the failure prevention task of FIG. 3, a task is shown in which the sensor information for the last 60 days before the execution of the task is acquired from the data collection/delivery server 1 and the failure prevention is executed based on the facility photograph and the gas turbine drawing.

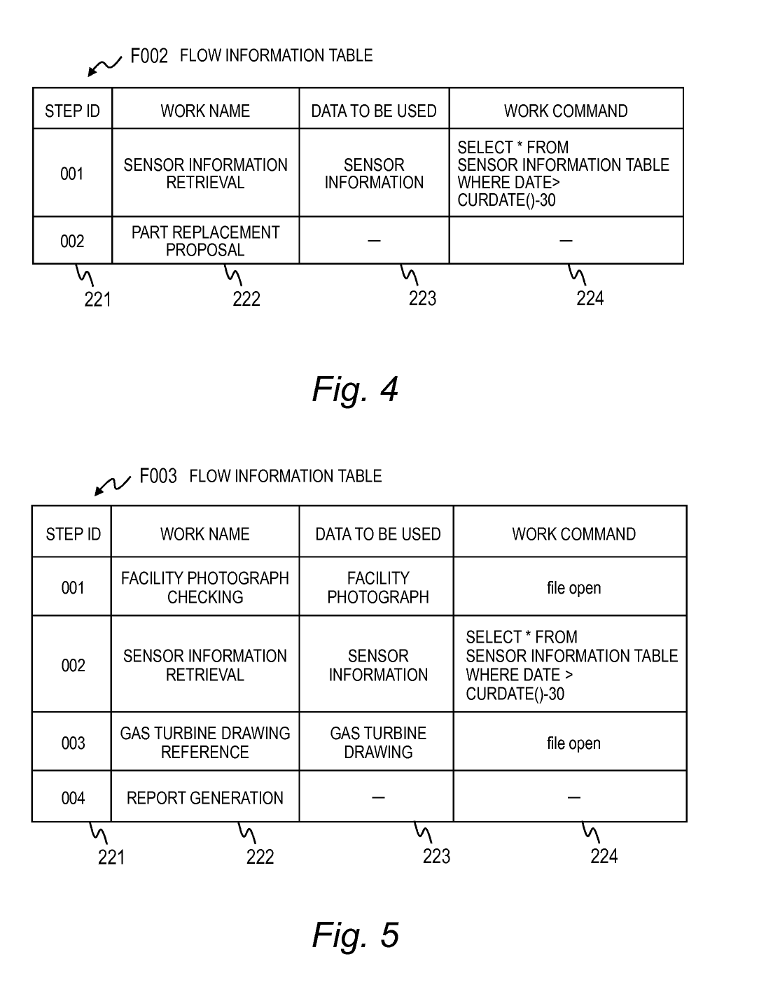

FIG. 4 is a diagram for showing an example of the flow information table (F002) for the part sales promotion task. A structure of the table is the same as in FIG. 3. In the task shown in FIG. 4, the sensor information for the last 30 days before the execution of the task is acquired from the data collection/delivery server 1 so as to generate a proposal on the replacement of a part.

FIG. 5 is a diagram for showing an example of the flow information table (F003) for the report generation task. A structure of the table is the same as in FIG. 3. In the task shown in FIG. 5, the facility photograph and the sensor information for the last 30 days before the execution of the task are acquired from the data collection/delivery server 1, and a report is generated through the use of the gas turbine drawing.

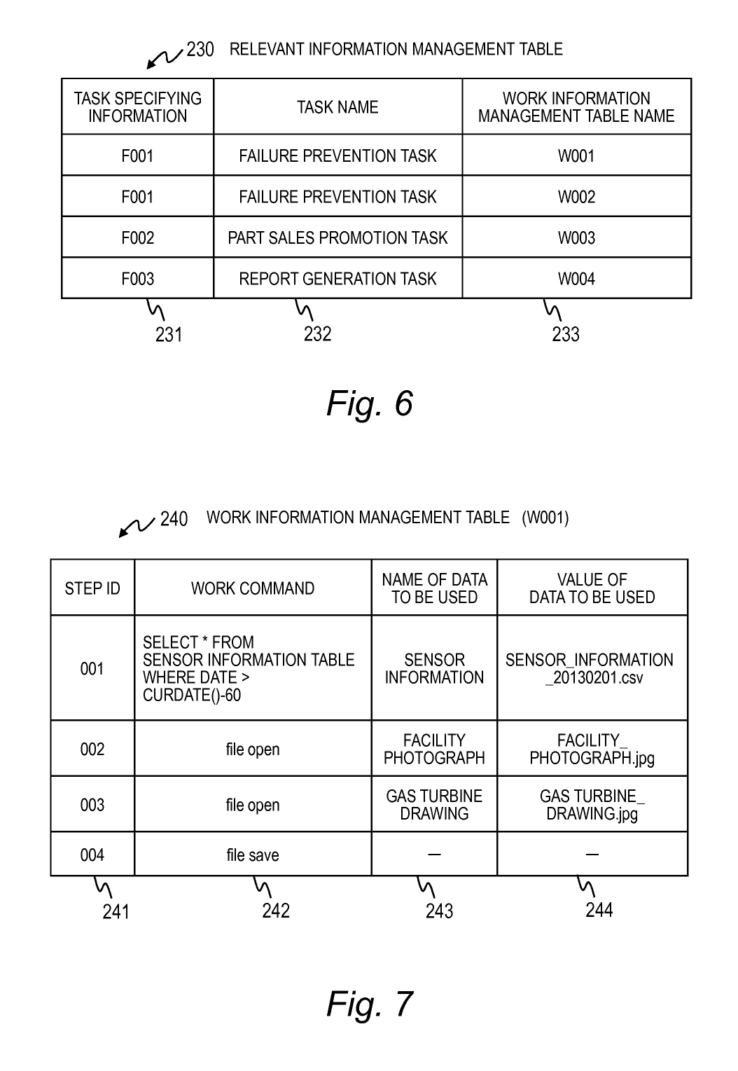

FIG. 6 is a diagram for showing an example of the relevant information management table 230. The relevant information management table 230 includes, in one record (or entry), task specifying information 231 for storing information specifying a task, a task name 232 for storing the name of the task, and a work information management table name 233 for storing the name of a table for recording the work information on the task.

In this case, the task specifying information 231 is information specifying one of the task flows (flow information tables), and the identifier of one of the task flows (F001 to F003) is used in this embodiment. However, the task specifying information 231 is not limited to an identifier, and only needs to be information that can specify a task, such as a name or a number.

FIG. 7 is a diagram for showing an example of the work information management table 240. In FIG. 7, an example is shown in which the work information management table name 233 shown in FIG. 6 is “W001”.

The work information management table 240 includes, in one record (or entry), a step ID 241 for storing the step ID 221 of one of the flow information tables F001 to F003, a work command 242 for storing a command to be used in the corresponding step, a name of data to be used (data specifying information) 243 for specifying data to be used in the corresponding step, and a value of data to be used 244 for storing a value of data to be used in the corresponding step.

The step ID 241 corresponds to the step ID 221 of the flow information table, the work command 242 corresponds to the work command 224 of the flow information table, and the name of data to be used 243 corresponds to the data to be used 223 of the flow information table.

The work information management table 240 shown in FIG. 7 corresponds to a case where the work information management table name 233 is “W001”, and the step ID 241 is the same as in the flow information table F001 of FIG. 3. Further, the value of data to be used 244 “sensor_information_{—}20130201.csv” to be used in the step ID “001” indicates that the sensor information for the last 60 days before the execution of the task (2013/2/1) is used by a query of the work command 242 as CSV data.

FIG. 19 is a diagram for showing an example of the relevance table 250. The relevance table 250 includes, in one record (or entry), task specifying information 1 (251) for storing information specifying a first task, task specifying information 2 (252) for storing information specifying a second task, and relevance 253.

The relevance table 250 is a table for setting the relevance 253 for every combination of the flow information tables F001 to F003. In the relevance table 250, when a flow information table is added, a record for combination of the added flow information table and one of the existing flow information tables (F001 to F003) is generated. Then, the relevance 253 is set through processing of the relevance calculation module 140, which is described later. It should be noted that processing of adding a record of the relevance table 250 every time the flow information table is added can be executed by the relevance calculation module 140.

It should be noted that the relevance table 250 and the relevant information management table 230 for defining data to be used in the task corresponding to the task specifying information may be defined in combination as association information. In the first embodiment, it is determined that pieces of task specifying information are relevant to each other when all of the data to be used in one of the task managed in the association information are the same as those of the other task.

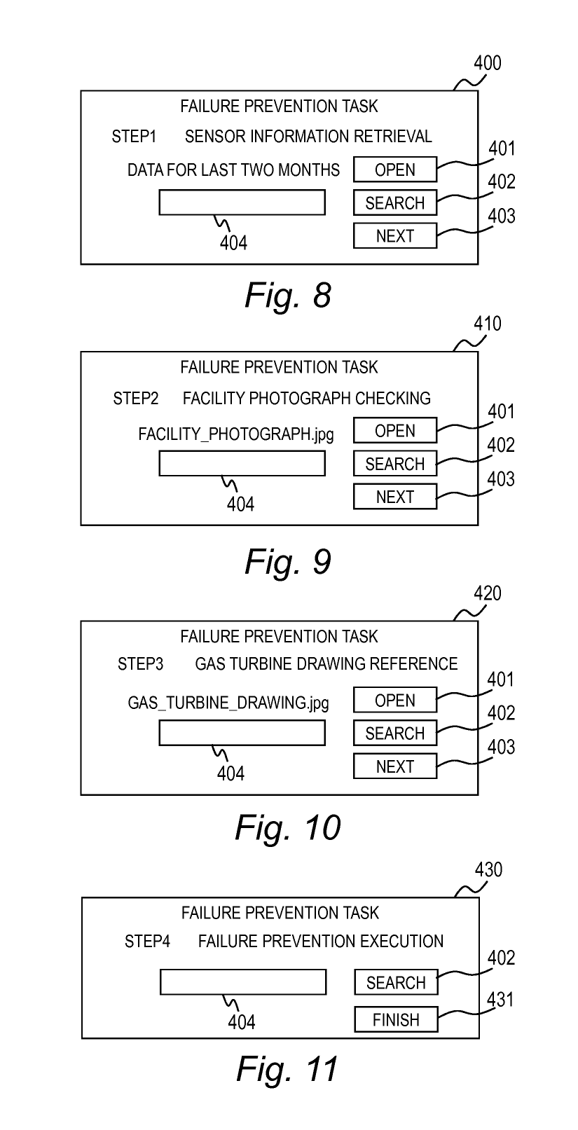

FIG. 8 to FIG. 11 are illustrations of screen images to be displayed on the display of the input/output apparatus 24 when the task client 2 executes the step IDs “001” to “004” of the failure prevention task.

In “STEP 1” of FIG. 8, a screen 400 includes an “open” button 401, a “search” button 402, a “next” button 403, and a search field (input field) 404 for designating data to be retrieved.

In “STEP 1” to “STEP 3”, because the name of data to be used is defined in the flow information table F001, when the task is started, data is already transferred to the task client 2 from the data collection/delivery server 1, and a user to execute the task can refer to this data by clicking the “open” button 401. It should be noted that desired sensor information can be acquired by clicking the “search” button 402 after inputting the condition to the search field 404 in order to change a period for collecting the sensor information. It should be noted that in order to proceed to the next step, the user only needs to click the “next” button 403.

In “STEP 2” of FIG. 9, a screen 410 includes the “open” button 401, the “search” button 402, the “next” button 403, and the search field 404 for designating data to be retrieved.

In “STEP 2”, because the name of data to be used “facility_photograph.jpg” is defined in the flow information table F001, a facility photograph is already transferred to the task client 2 from the data collection/delivery server 1, and a user to execute the task can refer to this photograph by clicking the “open” button 401. It should be noted that a desired facility photograph can be acquired by clicking the “search” button 402 after inputting the condition to the search field 404 in order to change the facility photograph. It should be noted that in order to proceed to the next step, the user only needs to click the “next” button 403.

In “STEP 3” of FIG. 10, a screen 420 includes the “open” button 401, the “search” button 402, the “next” button 403, and the search field 404 for designating data to be retrieved.

In “STEP 3”, because the name of data to be used “gas_turbine_drawing.jpg” is defined in the flow information table F001, a gas turbine drawing is already transferred to the task client 2 from the data collection/delivery server 1, and a user to execute the task can refer to this drawing by clicking the “open” button 401. It should be noted that a desired drawing can be acquired by clicking the “search” button 402 after inputting the condition to the search field 404 in order to change the gas turbine drawing. It should be noted that in order to proceed to the next step, the user only needs to click the “next” button 403.

In “STEP 4” of FIG. 11, a screen 430 includes the “search” button 402, a “finish” button 431, and the search field 404 for designating data to be retrieved. In “STEP 4”, the processing is finished when the “finish” button 431 is clicked.

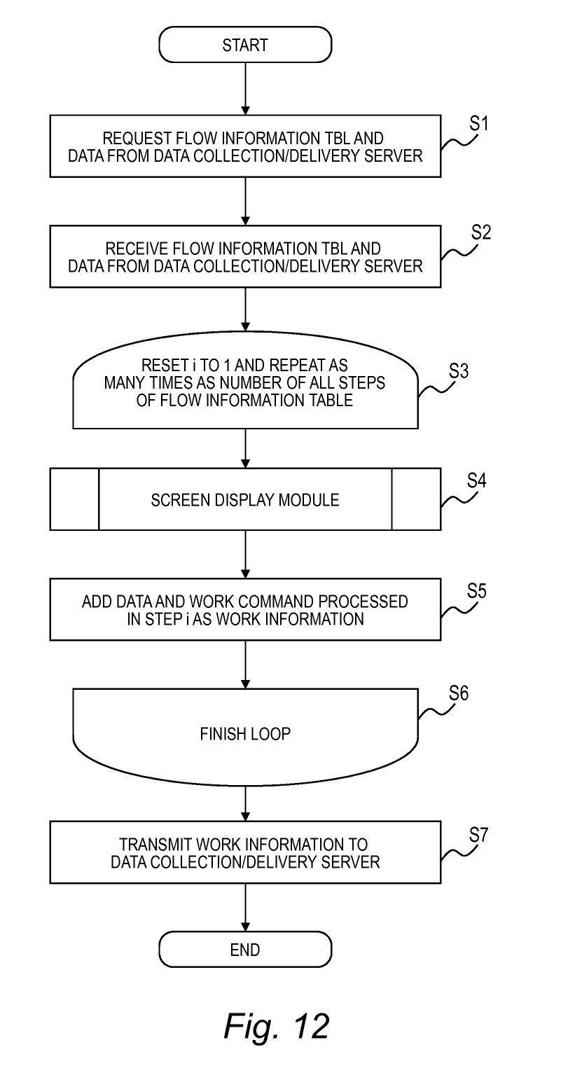

FIG. 12 is a flowchart for illustrating an example of processing to be executed by the task processing modules 23 of the task client 2. This processing is executed when the user of the task client 2 starts a task.

The task client 2 notifies the data collection/delivery server 1 of the task specifying information, and requests information of the flow information table and data to be used in the flow information table (S1). The task client 2 notifies the data collection/delivery server 1 of, as the task specifying information, the task specifying information 231 of the relevant information management table 230 of FIG. 6. For example, when starting the failure prevention task, the task client 2 notifies the data collection/delivery server 1 of the task specifying information “F001”.

When receiving the task specifying information and the request for the information of the flow information table and the data, the data collection/delivery server 1 selects one of the flow information tables F001 to F003 corresponding to the received task specifying information, and selects the data to be used in the flow information table from the data storage table 210. The data collection/delivery server 1 transmits the selected data and the information of the flow information table to the task client 2.

The task client 2 receives the data and the information of the flow information table from the data collection/delivery server 1 (S2). The task client 2 resets a variable i to 1, and repeats the processing of Step S3 to Step S6 as many times as the number of steps included in the received information of the flow information table.

In Step S4, the task client 2 executes the screen display module 22 as described later (S4). Next, the task client 2 holds the data and the work command that are processed in the step i of the flow information table as the work information (S5). In the same manner as in the work information management table 240 of FIG. 7, the step ID, the work command, the name of data to be used, and the value of data to be used are held on the main memory 21 of the task client 2 as the work information.

Next, the task client 2 determines whether or not every step of the flow information table has been finished. When not every step has been finished, the task client 2 increments the variable i, and returns to Step S3. When every step has been finished, the task client 2 proceeds to Step S7.

In Step S7, the task client 2 transmits the work information and the task specifying information that have been stored on the main memory 21 to the data collection/delivery server 1. The data collection/delivery server 1 that has received the work information and the task specifying information adds a new record to the relevant information management table 230. The data collection/delivery server 1 adds the task specifying information 231, the task name 232, and the work information management table name 233 to the added record of the relevant information management table 230. This work information management table name 233 is a new table name, the task specifying information 231 is information notified by the task client 2, and the task name 232 is a value set in advance in association with the task specifying information 231.

Further, the data collection/delivery server 1 adds the work information management table 240 corresponding to the new work information management table name 233. The data collection/delivery server 1 adds the work information received from the task client 2 to the new work information management table 240. It should be noted that when a new value of data to be used 244 is added to the work information management table 240, the data collection/delivery server 1 sets a new name as the name of the work information management table 240. It should be noted that the new name can be set using, for example, a serial number.

As described above, in the processing of FIG. 12, the work information management table 240 shown in FIG. 7 is added every time the task is executed. After the work information for generating the work information management table 240 is stored in the main memory 21 of the task client 2, when the task is finished, the stored work information is transmitted to the data collection/delivery server 1 and added as the new work information management table 240.

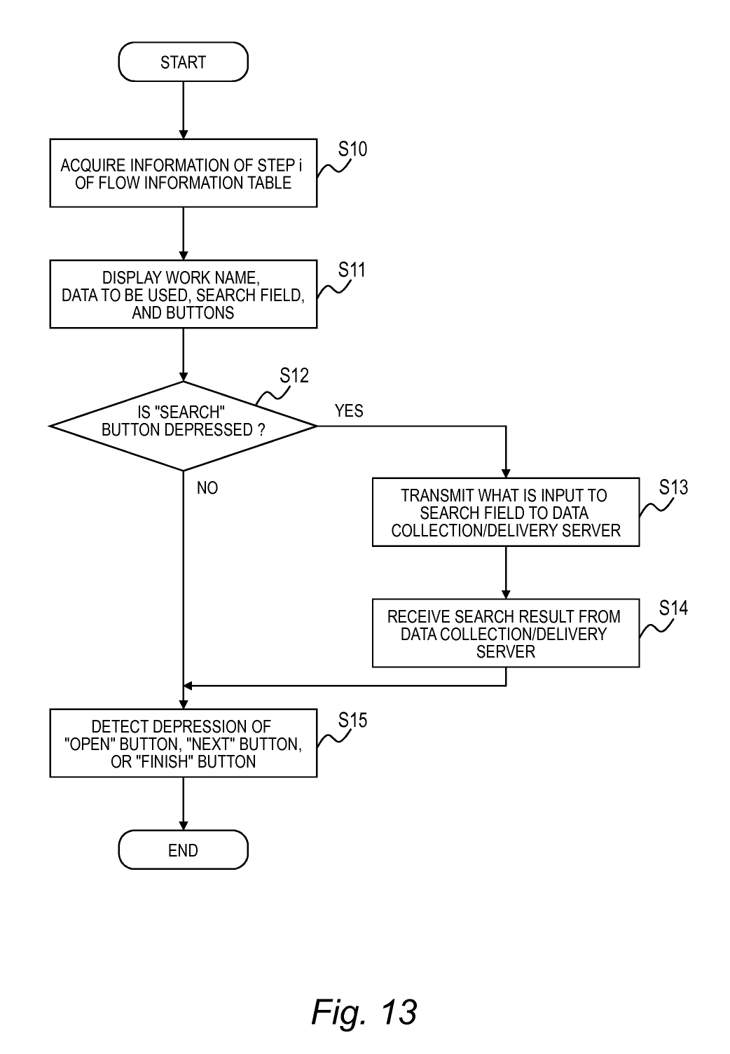

FIG. 13 is a flowchart for illustrating an example of processing to be executed by the screen display module 22 in Step S4 of FIG. 12. The screen display module 22 acquires the flow information table corresponding to a current step ID (S10).

Next, the screen display module 22 generates, based on the information of the acquired flow information table, display elements including the work name 222 and the data to be used 223 corresponding to the current step ID 221 and the search field (input field) 404 and the “search” button 402 that are to be displayed on the input/output apparatus 24, and outputs the generated display elements to the input/output apparatus 24 (S11). It should be noted that when the current step ID is the last step ID, the screen display module 22 outputs the “finish” button 431 in place of the “next” button 403.

Next, the screen display module 22 determines whether or not the “search” button 402 is clicked. When the “search” button 402 is clicked, the screen display module 22 proceeds to Step S13, and when another button is operated, the screen display module 22 proceeds to Step S15.

When the “search” button 402 is operated, Step S13 is executed, in which the task client 2 transmits what is input to the search field 404 and the current step ID to the data collection/delivery server 1. The data collection/delivery server 1 identifies the data to be used 223 to be used in the received step ID, and searches the data storage table 210 for corresponding data. The data collection/delivery server 1 transmits a search result to the task client 2 as a response.

The screen display module 22 receives the search result from the data collection/delivery server 1, and outputs the received search result to the input/output apparatus 24 (S14).

On the other hand, in Step S15, the screen display module 22 executes processing indicated by one of the buttons that is operated on one of the screens 400 to 430, and ends the processing. For example, when the “open” button 401 is clicked, the value of data to be used (“data for last two months” of FIG. 8″, “facility_photograph.jpg” of FIG. 9, or “gas_turbine_drawing.jpg” of FIG. 10) corresponding to the current step ID is opened to be output to the input/output apparatus 24, and when the “next” button 403 is operated, the task client 2 proceeds to the next step ID.

Through the processing described above, the screen display module 22 of the task client 2 can output information corresponding to the step ID to the input/output apparatus 24 and pass the received search condition to the data collection/delivery server 1 to request the data collection/delivery server 1 to perform a search.

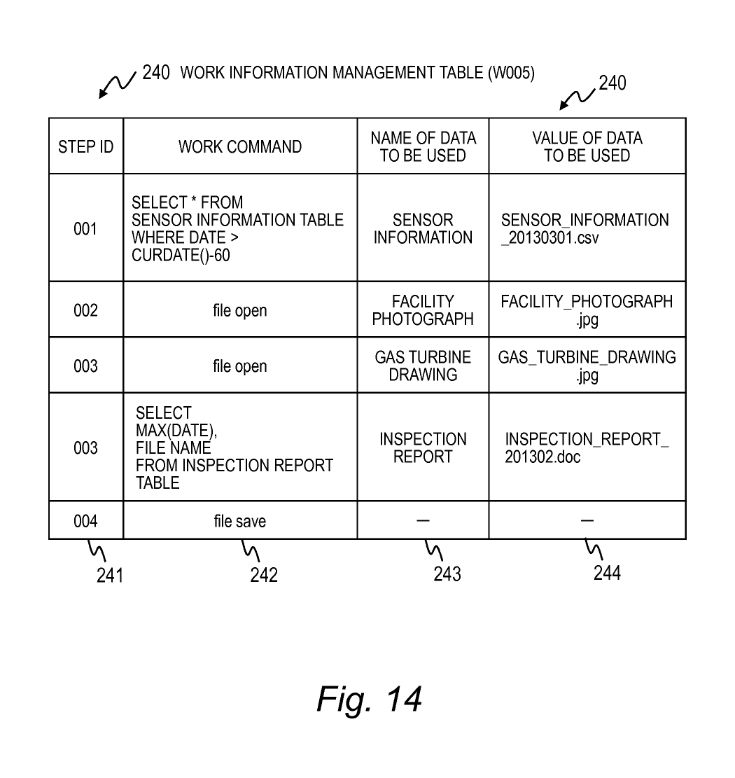

FIG. 14 is a diagram for showing an example of the work information management table 240 obtained by adding a new record. The work information management table 240 is shown in FIG. 14, which is obtained when the inspection report is used in addition to the gas turbine drawing in the step ID “003” at the time of execution of the failure prevention task (e.g., 2013/3/1).

As compared with the work information management table 240 (W001) shown in FIG. 7, the inspection report of the step ID “003” is added next to the step ID “003”, and a new work information management table name “W005” is set.

At this time, a query used by the task client 2 to inquire the data collection/delivery server 1 is recorded in the work command 242. The work command 242 records that the latest inspection report is selected from an inspection report table of the data storage table 210 in this query. The work command 242 also records that “inspection_report_{—}201302.doc” of the value of data to be used of FIG. 14 indicates that as a result of the search, the latest inspection report at the time of execution of the failure prevention task is the inspection report generated in February, 2013.

The task client 2 holds, in addition to the information acquired from the flow information table, details of work of the user of the task client 2 who has executed the task as the work information, and transmits the held work information to the data collection/delivery server 1 after finishing the task. With this, the data collection/delivery server 1 can add the details of work newly added by the user to the work information management table 240.

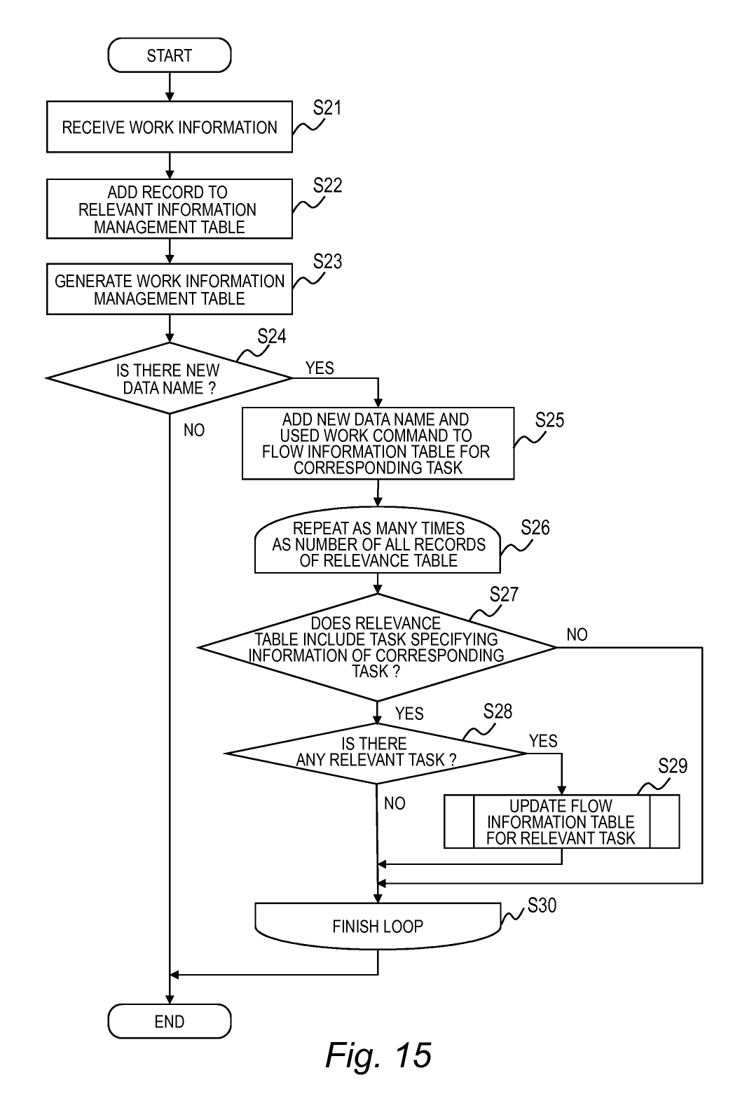

FIG. 15 is a flowchart for illustrating an example of processing to be executed by the relevant information processing module 130. The data collection/delivery server 1 starts the processing of the relevant information processing module 130 when receiving the work information from the task client 2. In other words, this processing is started after the task client 2 transmits the work information and the task specifying information in Step S7 of FIG. 12.

In Step S21, the relevant information processing module 130 receives the work information and the task specifying information, which have been received by the data collection/delivery server 1.

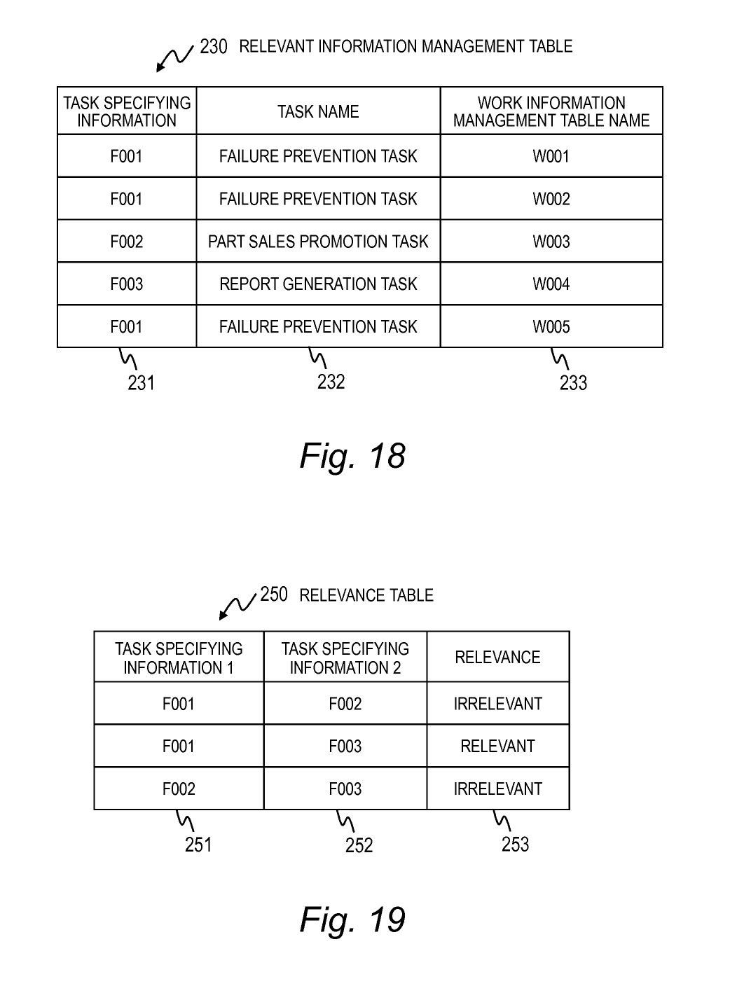

The relevant information processing module 130 adds a new record to the relevant information management table 230 (S22). The relevant information processing module 130 adds the task specifying information 231, the task name 232, and the work information management table name 233 to the added record of the relevant information management table 230. In this case, the work information management table name 233 is a new table name, the task specifying information 231 is information notified by the task client 2, and the task name 232 is a value set in advance in association with the task specifying information 231. It should be noted that the new table name can be set by the relevant information processing module 130 using a serial number or the like. For example, the work information management table name 233 “W005” shown in FIG. 18 is set using the serial number. It should be noted that the table of FIG. 18 is the relevant information management table 230 obtained after a new record (W005) is added to the table of FIG. 6.

The relevant information processing module 130 adds the work information management table 240 having the new work information management table name 233. The relevant information processing module 130 adds the work information received from the task client 2 to the added new work information management table 240 (S23).

The relevant information processing module 130 determines whether or not the name of data to be used 243 of the work information management table 240 having the new work information management table name 233 is included in the data to be used 223 of one of the flow information tables F001 to F003 for the corresponding task. When the name of data to be used 243 is a new name that does not exist in the data to be used 223 of the flow information table, the relevant information processing module 130 proceeds to Step S25. When the name of data to be used 243 is not a new name, the processing ends (S24).

In Step S25, the relevant information processing module 130 adds the step ID 241, the work command 242, the name of data to be used 243, and the value of data to be used 244 that are set in the work information management table 240 to the flow information table corresponding to the current task specifying information (S25).

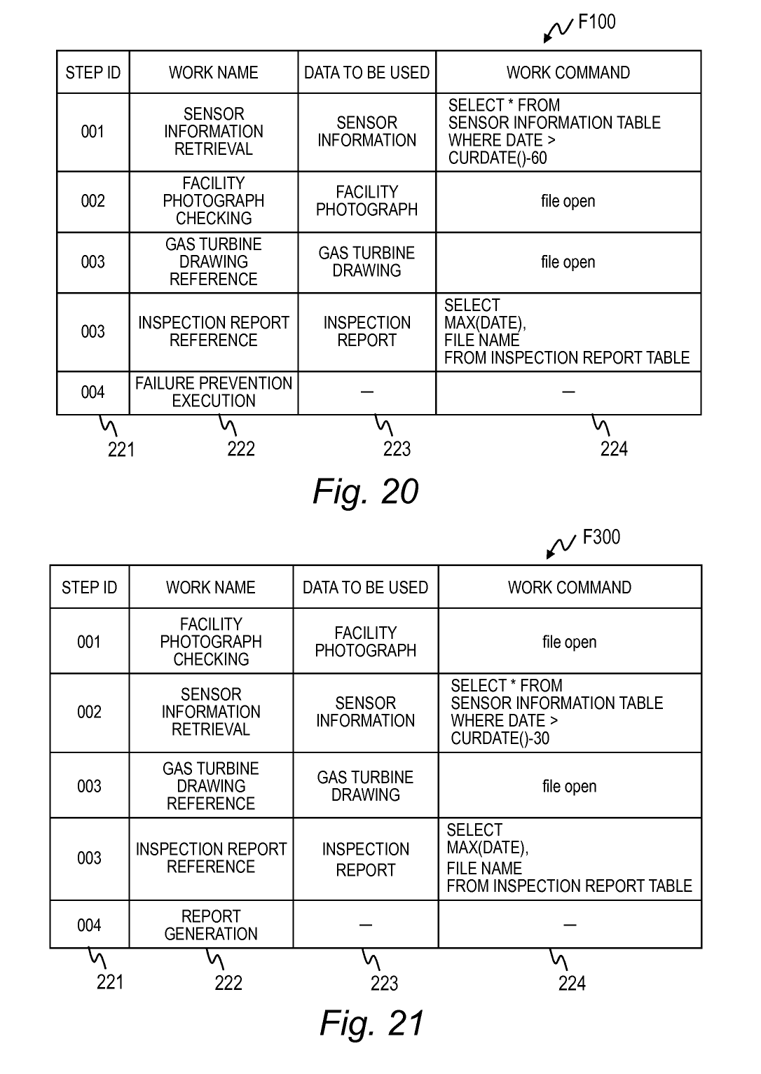

For example, in the flowchart of FIG. 12, when the task client 2 executes the failure prevention task having the task specifying information “F001” and uses the “inspection report”, which does not exist in the data to be used 223 of the original flow information table F001, the relevant information processing module 130 adds a new record to the flow information table F001 shown in FIG. 3. Specifically, when the task client 2 executes the failure prevention task and adds “003” as the step ID and “inspection report” as the name of data to be used 243 as shown in FIG. 14, the relevant information processing module 130 adds, after the record having the step ID “003” of the flow information table F001 shown in FIG. 3, a record in which the step ID 221 is “003”, the work name 222 is “inspection report reference”, the data to be used 223 is “inspection report”, and the work command 224 is the work command 242 of FIG. 14 as shown in FIG. 20. It should be noted that the work name 222 “inspection report reference” is obtained by automatically adding a task name “reference” to the name of data to be used 243 “inspection report” of FIG. 14.

Next, the relevant information processing module 130 opens the relevance table 250 shown in FIG. 19. Then, the relevant information processing module 130 repeatedly executes the processing of Step S26 to Step S30 for every record of the relevance table 250.

The relevant information processing module 130 identifies the task specifying information corresponding to one of the flow information tables F001 to F003 to which the new record is added in Step S25. Then, the relevant information processing module 130 determines whether or not the identified task specifying information is included in the relevance table 250 sequentially in order from the first record to the last record (S27).

When the identified task specifying information is included in any one of the task specifying information 1 (251) and the task specifying information 2 (252) of the relevance table 250, the relevant information processing module 130 proceeds to Step S28. When the identified task specifying information is not included in any of the current records of the relevance table 250, the relevant information processing module 130 proceeds to Step S30.

In Step S28, the relevant information processing module 130 determines whether or not the relevance 253 of the record of the relevance table 250 including the identified task specifying information indicates “relevant” or “irrelevant”. When the relevance 253 indicates “relevant”, the relevant information processing module 130 proceeds to Step S29. When the relevance 253 indicates “irrelevant”, the relevant information processing module 130 proceeds to Step S30.

In Step S29, as described later, the relevant information processing module 130 updates one of the flow information tables F001 to F003 for the task relevant to the identified task specifying information. Then, the relevant information processing module 130 proceeds to the processing of Step S30.

In Step S30, when the processing after Step S26 is not finished for every record of the relevance table 250, the relevant information processing module 130 selects the next record, returns to Step S26, and repeats the processing. On the other hand, when the processing after Step S26 is finished for every record of the relevance table 250, the relevant information processing module 130 ends the processing.

Through the processing described above, when the task client 2 transmits the work information and the task specifying information, the relevant information processing module 130 of the data collection/delivery server 1 adds a new record to the relevant information management table 230, and sets the table name 233 as the received work information. Then, the relevant information processing module 130 generates a new work information management table 240 based on the received work information while assigning the new table name 233 to the new work information management table 240.

Then, when the task specifying information specifying the task executed by the task client 2 is included in the relevance table 250 and is relevant to another task, the relevant information processing module 130 updates the flow information table of the relevant task as described later. For example, when the task specifying information specifying the task executed by the task client 2 is F001 (failure prevention task), it is determined based on the relevance table 250 that the task specifying information 2 “F003” is relevant to the task specifying information “F001”.

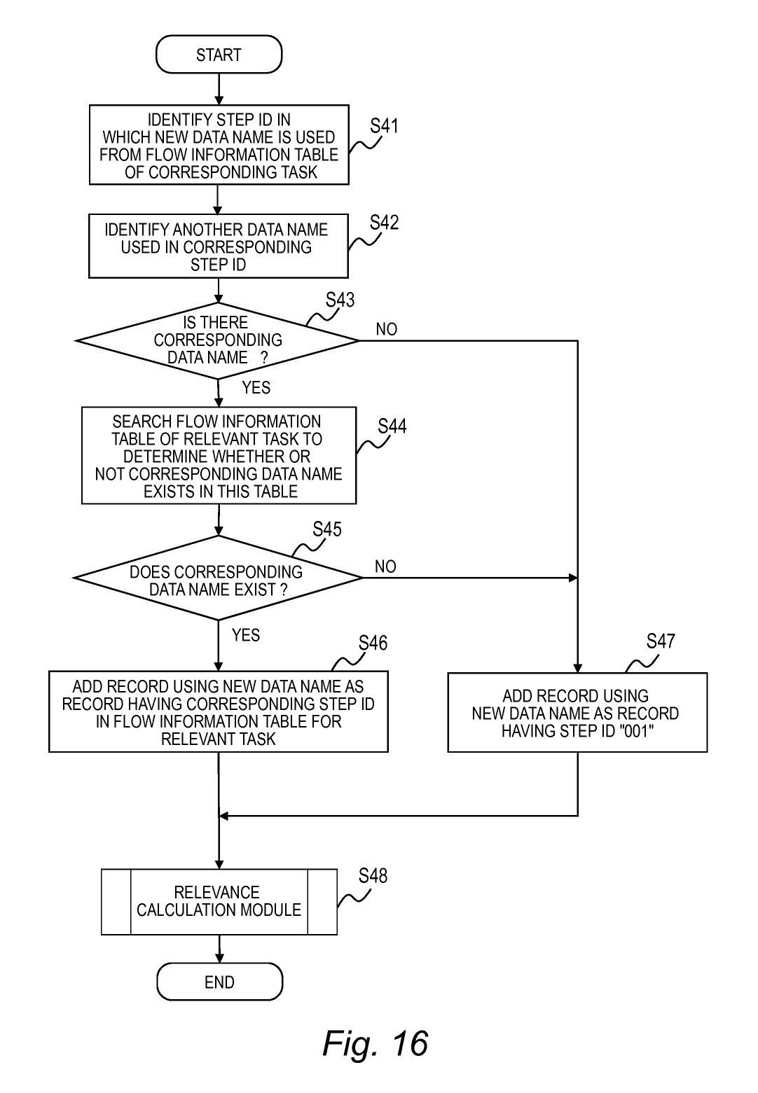

FIG. 16 is a flowchart for illustrating an example of processing to be executed by the relevant information processing module 130 to update the flow information table for a relevant task. This processing is executed by the relevant information processing module 130 of the data collection/delivery server 1 in Step S29 of FIG. 15.

First, as described above with reference to FIG. 15, when the name of data to be used 243 is a new name that does not exist in the data to be used 223 of the flow information table, the relevant information processing module 130 identifies the step ID in which the new name is used from the flow information table for the corresponding task specifying information (S41). Then, the relevant information processing module 130 identifies, in the same step ID as the identified step ID (221), the name of the data to be used (223) that is different from the new name (S42).

Specifically, when “inspection report” is added to the flow information table F001 of FIG. 3 as the data to be used (223) of the step ID “003” in Step S25 of FIG. 15, the relevant information processing module 130 identifies “gas turbine drawing” in the same step ID “003”, which differs in its name of the data to be used (223) (S43).

Next, the relevant information processing module 130 determines whether or not the data to be used having a different name exists in the same step ID. When the data to be used having a different name exists in the same step ID, the relevant information processing module 130 proceeds to Step S44, and otherwise, the relevant information processing module 130 proceeds to Step S47.

In Step S44, the relevant information processing module 130 searches the flow information table of the relevant task to determine whether or not the corresponding data to be used exists in this table. Specifically, in the processing of FIG. 15, when the relevant information processing module 130 adds “inspection report” having the step ID “003” to the flow information table F001 shown in FIG. 3, the relevant information processing module 130 identifies “gas turbine drawing” as another piece of data to be used that differs in its name from the data to be used 223 of the same step ID “003”.

Then, in the processing of FIG. 15, the task relevant to the task specifying information “F001” is the task specifying information 2 “F003” as shown in FIG. 19.

In Step S44, the relevant information processing module 130 searches the data to be used 223 of the flow information table F003 for the data to be used (223) including “gas turbine drawing” identified in Step S43.

Next, the relevant information processing module 130 determines whether or not the data to be used (223) including “gas turbine drawing” identified in Step S43 exists in the relevant flow information table (S45). When the data to be used including the name identified in Step S43 exists in the flow information table relevant to the corresponding task specifying information, the relevant information processing module 130 proceeds to Step S46. When the corresponding data to be used does not exist, the relevant information processing module 130 proceeds to Step S47.

In Step S46, the relevant information processing module 130 adds, to the flow information table (F003) for the relevant task, a record that is added in the processing of FIG. 15, and has “inspection report” as the data to be used, in the same manner as the flow information table F001. With this, in the flow information table F003 relevant to the flow information table F001, the record having “inspection report” as the data to be used 223 is added to the step ID “003” as shown in FIG. 21. It should be noted that “inspection report reference” as the work name 222 of FIG. 21 is the same as in the flow information table F100 of FIG. 20, and the work command 224 of FIG. 21 is the work command 242 stored in the same record as the record of the work information management table 240 shown in FIG. 14 that has “inspection report” as the name of data to be used 243.

Next, in Step S48, because the work information management table 240 is newly generated, relevance of the task specifying information is updated as described later.

On the other hand, when the determination of Step S43 or Step 45 results in “No”, the relevant information processing module 130 proceeds to Step S47, and the relevance is calculated in Step S48. Then, the relevant information processing module 130 ends the processing.

Through the processing described above, when new data to be used 223 is added in the flow information table F001, the same record as the record for the added step ID is added to the flow information table for a different task relevant to this flow information table F001.

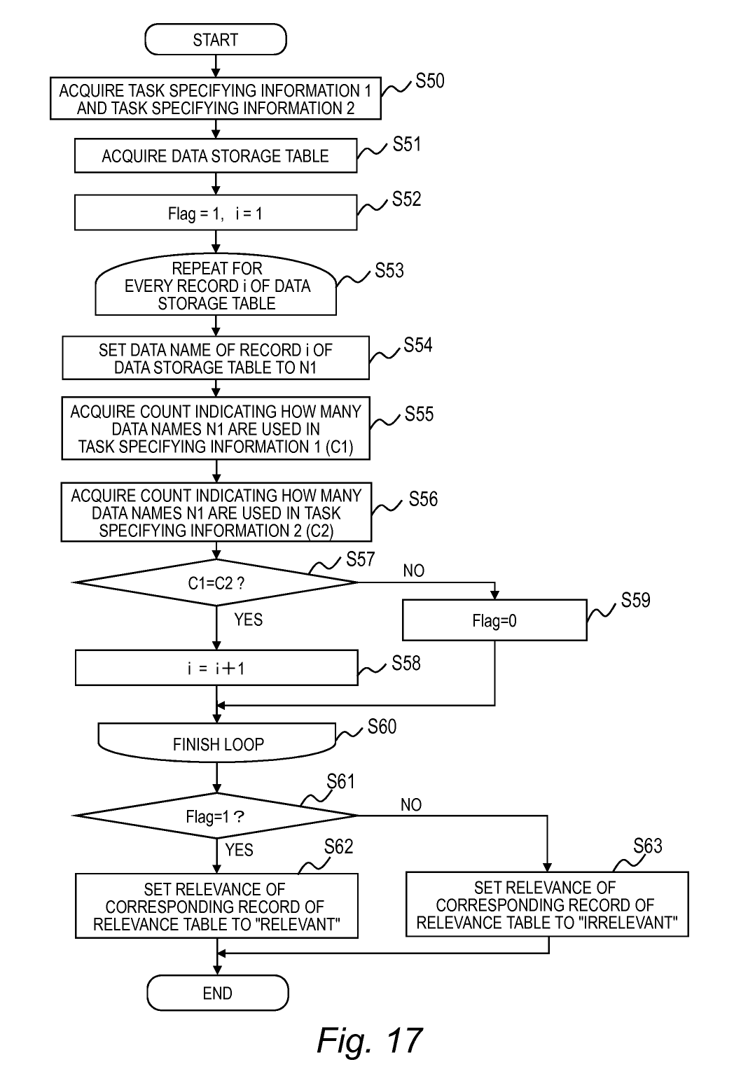

FIG. 17 is a flowchart for illustrating an example of processing to be executed by the relevance calculation module 140. This processing is processing executed in Step S48 of FIG. 16. The relevance is calculated for the record of the relevance table 250 selected in the loop of Step S26 to Step S30 of FIG. 15. In the first embodiment, when the data used in the flow information tables corresponding to a pair of the task specifying information 1 and the task specifying information 2 of the relevance table 250 are the same, it is determined that the task specifying information 1 and the task specifying information 2 are relevant to each other, and the relevance 253 of the relevance table 250 is updated.

The relevance calculation module 140 reads the record of the relevance table 250 selected in the loop of Step S26 to Step S30 of FIG. 15, and acquires the task specifying information 1 (251) and the task specifying information 2 (252) shown in FIG. 19 (S50). Further, the relevance calculation module 140 acquires the data storage table 210 (S51).

The relevance calculation module 140 resets a variable Flag to 1, and resets a variable i to 1 (S52).

The relevance calculation module 140 repeats the processing of Step S53 to Step S60 for every record of the data storage table 210 while Flag is 1.

The relevance calculation module 140 reads the data name 212 of the i-th record of the data storage table 210 acquired in Step S51 and assigns the read data name to a variable N1 (S54). When i=1, N1 is “sensor information”.

Next, the relevance calculation module 140 acquires a count indicating how many data names N1 acquired in Step S54 are used in the data to be used 223 of the flow information table of the task specifying information 1 (251), and assigns the acquired count to a variable C1 (S55). In the case of the flow information table F001, the use count of “sensor information” is 1.

Next, the relevance calculation module 140 acquires a count indicating how many data names N1 acquired in Step S54 are used in the data to be used 223 of the flow information table of the task specifying information 2 (252), and assigns the acquired count to a variable C2 (S56). Also in the case of the flow information table F003, the use count of “sensor information” is 1.

The relevance calculation module 140 determines whether or not the variables C1 and C2 are equal to each other (S57). When the variables C1 and C2 are equal to each other, the relevance calculation module 140 proceeds to Step S58 while maintaining Flag to 1. When the variables C1 and C2 are not equal to each other, the relevance calculation module 140 proceeds to Step S59, and updates Flag to 0.

In Step S58, the relevance calculation module 140 adds 1 to the variable i, and proceeds to the processing for the next record of the data storage table 210.

In Step S60, when Flag is 1, and when the processing has not been finished for every record of the data storage table 210, the relevance calculation module 140 resets the variables C1 and C2 to 0, and then returns to Step S53 to repeat the processing. On the other hand, when Flag is not 1, or when the processing has been finished for every record of the data storage table 210, the relevance calculation module 140 finishes the loop of Step S53 to Step S60, and proceeds to Step S61.

In Step S61, the relevance calculation module 140 determines whether or not Flag is 1. When Flag is 1, the relevance calculation module 140 proceeds to Step S62, and when Flag is not 1, the relevance calculation module 140 proceeds to Step S63. In Step S62, the relevance calculation module 140 determines that the task specifying information 1 and the task specifying information 2 of the relevance table 250 that are read in Step S51 are relevant to each other, and sets “relevant” as the relevance 253 of the relevance table 250.

On the other hand, in Step S63, the relevance calculation module 140 determines that the task specifying information 1 and the task specifying information 2 of the relevance table 250 that are read in Step S51 are irrelevant to each other, and sets “irrelevant” as the relevance 253 of the relevance table 250.

Through the processing described above, during the loop processing of Step S26 to Step S30 of FIG. 15 for the relevance table 250, the relevance between the task specifying information 1 (251) and the task specifying information 2 (252) can be determined based on whether or not the data to be used 223 in the task specifying information 1 is the same as the data to be used 223 of the task specifying information 2. In other words, when all of the data to be used 223 used in the flow information table for the task specifying information 1 are also used in the flow information table for the task specifying information 2, the task specifying information 1 and the task specifying information 2 can be determined as being relevant to each other.

In short, according to the first embodiment, when the data processed in one task is perfectly the same as the data processed in another task, those different tasks can be determined as being relevant to each other.

FIG. 20 is a diagram for showing an example of the flow information table F100 for the failure prevention task after the processing of the relevant information processing module 130 of FIG. 15 is completed. In FIG. 20, a record having “inspection report” as the data to be used 223 is added to the step ID 221 “003”. This table is obtained as a result of execution of the task by the task client 2 using the flow information table F001 for the failure prevention task. In the same manner as in the work information management table 240 (W005) of FIG. 14, the task client 2 adds the step ID “003” for referring to the inspection report to the next step of the name of data to be used 243 “gas turbine drawing” of the step ID “003”, and the added step ID “003” is reflected in the flow information table F001.

FIG. 21 is a diagram for showing an example of the flow information table F300 for the report generation task after the processing of the relevant information processing module 130 executed in Step S29 of FIG. 15 is completed.

When new data to be used 223 is added to the flow information table F001, the relevant information processing module 130 adds, in the processing of FIG. 15, the same step as the one added to the flow information table F001 also to the flow information table F003, which is another flow information table relevant to the flow information table F001.

In this manner, also in the flow information table F003, the step ID “003” for referring to “inspection report” is added as the next step to the data to be used 223 “gas turbine drawing” of the step ID “003”.

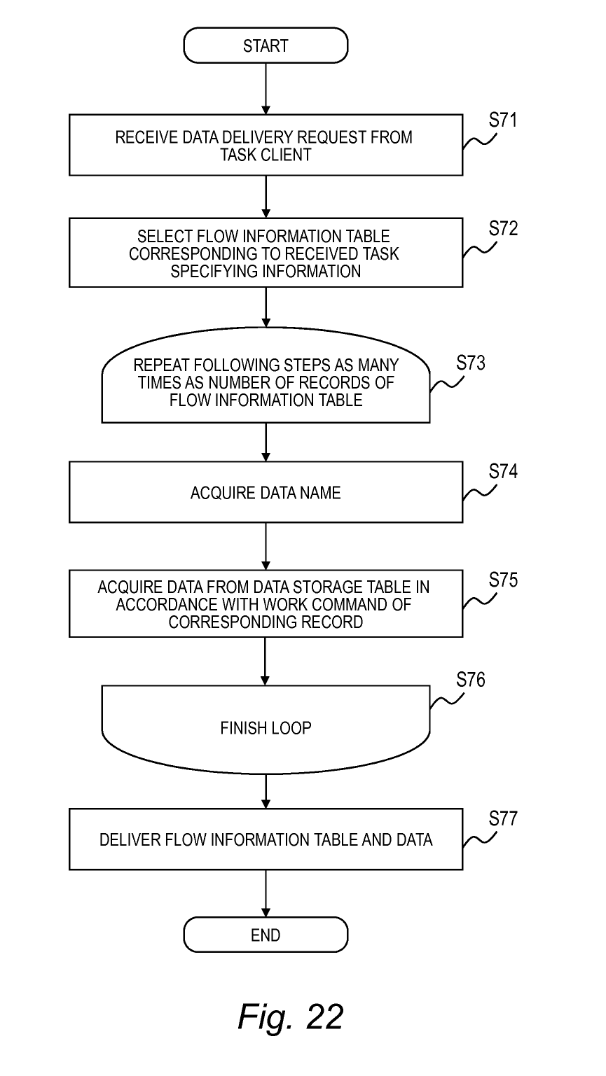

FIG. 22 is a flowchart for illustrating an example of processing to be executed by the data delivery processing module 120. This processing is executed by the data delivery processing module 120 when the task client 2 requests the flow information table or the like from the data delivery processing module 120 in order to start the task.

The data delivery processing module 120 receives a data delivery request from the task client 2 (S71). This processing includes, as illustrated in Step S1 of FIG. 12, making a request for the task specifying information and data of the flow information table by the task client 2.

The data delivery processing module 120 refers to the relevant information management table 230 to read the flow information table corresponding to the received task specifying information (S72). Next, the data delivery processing module 120 repeats the processing of Step S73 to Step S76 as many times as the number of records of the flow information table.

The data delivery processing module 120 identifies the data to be used 223 for each of the acquired records of the flow information table (S74). Next, the data delivery processing module 120 acquires the work command 224 of the current record, and acquires data from the data storage table 210. In other words, the data delivery processing module 120 executes the work command 224 so as to acquire data having the name designated in the data to be used 223 from the data storage table 210.

When executing the processing described above until the last record of the flow information table, the data delivery processing module 120 finishes the loop processing of Step S73 to Step S76, and proceeds to Step S77.

In Step S77, the data delivery processing module 120 delivers, to the task client 2, the data acquired by executing the work command 224 and the information (records) of the flow information table corresponding to the task specifying information, and ends the processing.

As described above, according to the first embodiment, when the task client 2 adds new data to be used and a work command to the information of the existing flow information table, the data collection/delivery server 1 adds a record including the new data to be used and work command to the corresponding flow information table (e.g., F001). Then, the relevant information processing module 130 refers to the relevance table 250 to retrieve the flow information table relevant to the flow information table (F001) to which the record is added. When the relevant flow information table (e.g., F003) exists, the data collection/delivery server 1 adds the record added to the original flow information table to the relevant flow information table (e.g., F003) as well. With this, it is possible to present details of improvement in a specific task acquired in the specific task to another task relevant to the specific task.

Further, when all of the data to be used 223 used in the flow information table for the task specifying information 1 are also used in the flow information table for the task specifying information 2, the task specifying information 1 and the task specifying information 2 can be determined as being relevant to each other. With this, through comparison of data processed in respective tasks from an enormous amount of data, it is possible to calculate the relevance between the different tasks.

Further, in this embodiment, an example is described in which the data name 212 of the data storage table 210, the data to be used 223 of one of the flow information tables F001 to F003, and the name of data to be used 243 of the work information management table 240 are used as the data specifying information for specifying the data to be used by each task. The data specifying information can be formed of a name, identifier, or number specifying data, and is information that can specify data within the computer system.

### Second Embodiment

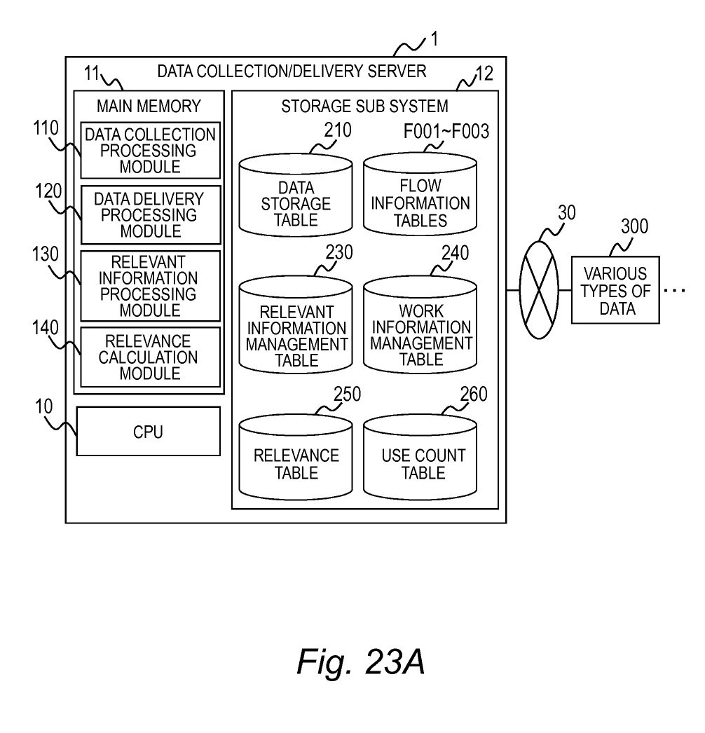

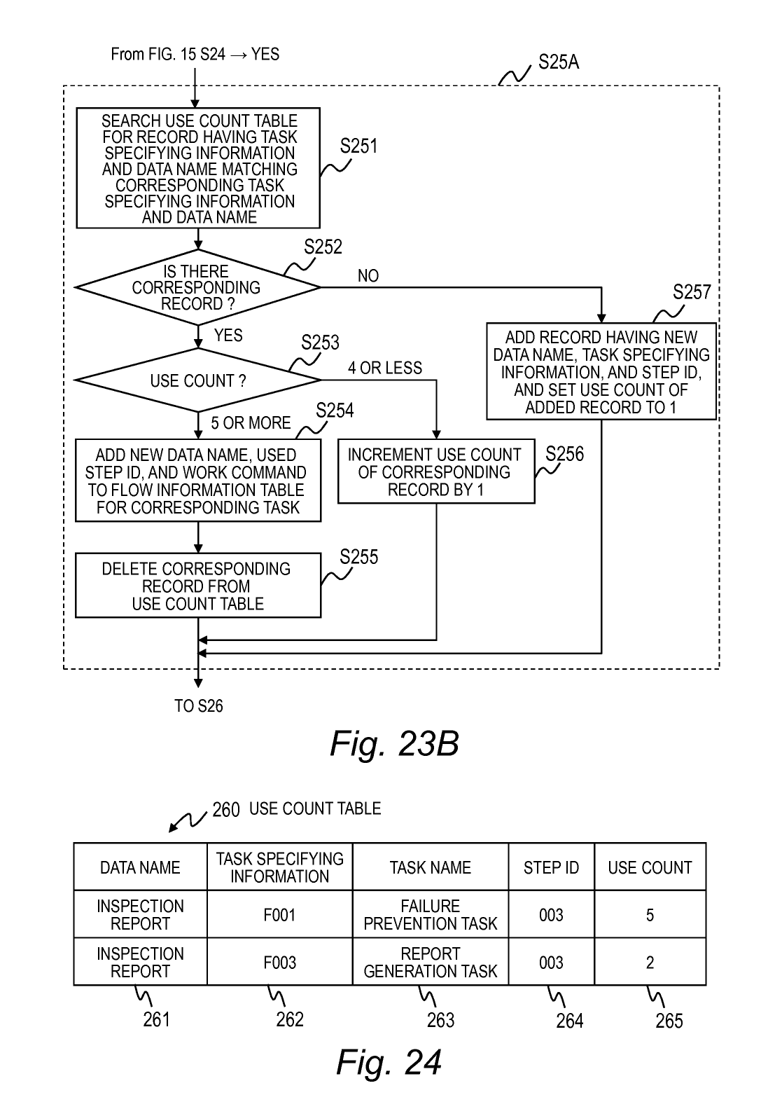

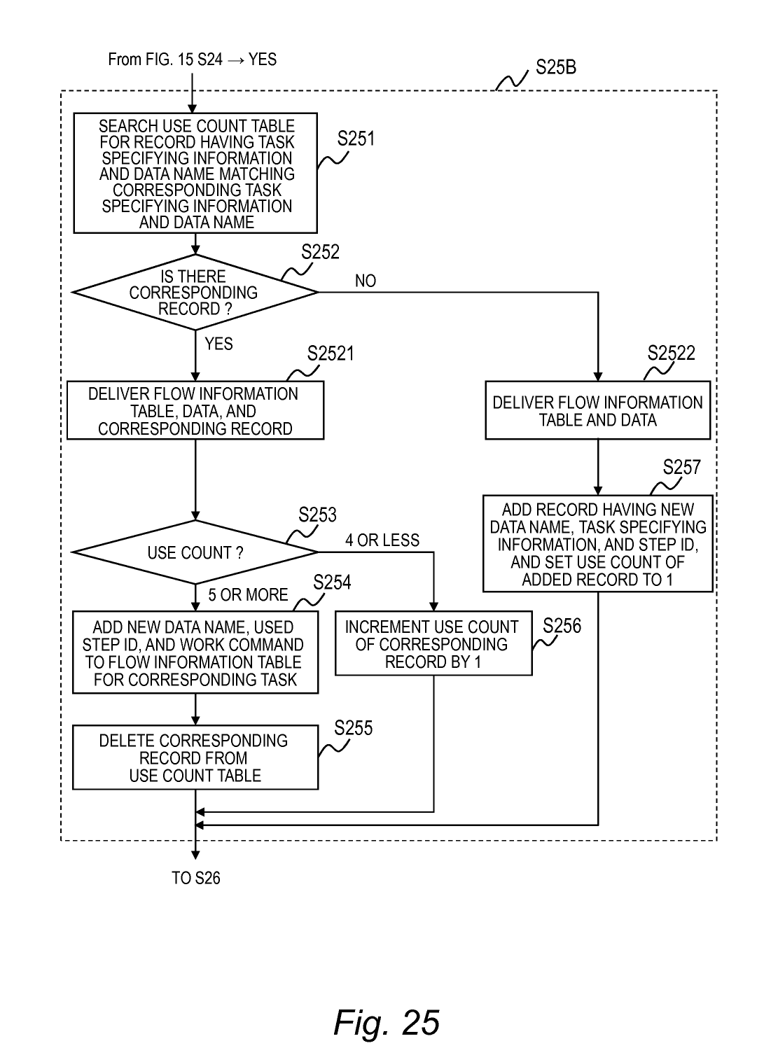

FIG. 23A, FIG. 23B, and FIG. 24 are illustrations of a second embodiment of this invention. In the first embodiment, an example is described in which when the task client 2 adds new data to be used and a work command to the information of the flow information table, the data collection/delivery server 1 automatically adds the record using the added data to be used to the flow information table. A data collection/delivery server 1 according to the second embodiment is configured to hold, when the task client 2 adds new data to be used and work command to the information of the flow information table, a new record to which the added new data to be used and a work command are added. The data collection/delivery server 1 is further configured to add, only after the use count of the new record becomes a predetermined threshold or more, the record using the new data to be used and work command to the flow information table. Other parts of the configuration of the second embodiment are the same as in the first embodiment.

FIG. 23A is a block diagram for illustrating an example of a configuration of the data collection/delivery server 1. In the data collection/delivery server 1, a use count table 260 is added to the configuration of the first embodiment to be stored in the storage sub system 12. Other parts of the configuration of the data collection/delivery server 1 are the same as in the first embodiment.

FIG. 24 is a diagram for showing an example of the use count table 260. The use count table 260 is managed by the relevant information processing module 130 as described later.

The use count table 260 includes, in one record (or entry), a data name 261 for storing the name of the data to be used that is added to the flow information table, task specifying information 262 for storing information specifying the flow information table, a task name 263 for storing the name of the task corresponding to the task specifying information, a step ID 264 for storing an identifier of a step of the flow information table using the corresponding data, and a use count 265 for storing a count indicating how many times the data corresponding to the data name 261 has been used by the task client 2.

The data name 261 corresponds to the data to be used 223 of the flow information table and the name of data to be used 243 of the work information management table 240. The task specifying information 262 corresponds to the task specifying information 231 of the relevant information management table 230. The task name 263 corresponds to the work name 222 of the flow information table and the task name 232 of the relevant information management table 230. The step ID 264 corresponds to the step ID 241 of the flow information table and the step ID 241 of the work information management table 240.

FIG. 23B is a flowchart for illustrating an example of processing to be executed by the relevant information processing module 130. This flowchart is processing to be executed in place of Step 25 of FIG. 15 according to the first embodiment (S25A), and includes Step S251 to Step S257.

When determining in Step S24 of FIG. 15 that the name of data to be used 243 is a new name that does not exist in the data to be used 223 of the flow information table, the relevant information processing module 130 proceeds to Step S251.

The relevant information processing module 130 searches the use count table 260 for a record in which the task specifying information corresponding to the name of data to be used 243 is the same as the task specifying information 262 of the use count table 260 and the new name of data to be used 243 is the same as the data name 261 of the use count table 260 (S251).

The relevant information processing module 130 determines whether or not a record to be retrieved is found as the search result in Step S251 (S252). When the record to be retrieved is found, the relevant information processing module 130 proceeds to Step S253, and when no record to be retrieved is found, the relevant information processing module 130 proceeds to Step S257.

In Step S253, the relevant information processing module 130 acquires the use count 265 of the record found as the search result to determine whether or not the acquired use count 265 is 5 or more, which is the predetermined threshold (S253). When the use count 265 of the corresponding record is the threshold or more, the relevant information processing module 130 proceeds to Step S254, and when the use count 265 of the corresponding record is less than the threshold (“4 or less” in FIG. 23B), the relevant information processing module 130 proceeds to Step S256.

In Step S254, because the data name 261 of the corresponding record of the use count table 260 has been used for a predetermined number of times, the relevant information processing module 130 adds the data name 261 to the corresponding one of the flow information tables F001 to F003. This processing is the same as in Step S25 illustrated in FIG. 15 according to the first embodiment.

Then, the relevant information processing module 130 deletes the record of the data name 261 added to one of the flow information tables F001 to F003 from the use count table 260.

On the other hand, when the use count 265 is less than the threshold, the relevant information processing module 130 adds “1” to the use count 265 of the corresponding record of the use count table 260.

On the other hand, when it is determined in Step S252 that no record to be retrieved is found, the relevant information processing module 130 adds a new record to the use count table 260. Then, the relevant information processing module 130 sets new data name 261, task specifying information 262, task name 263, and step ID 264 based on the information set in the work information management table 240 and the relevant information management table 230 in Step S21 and Step S22 of FIG. 15.

When the processing of any one of Step S255 to Step S257 is finished, the relevant information processing module 130 proceeds to the processing of Step S26 of FIG. 15.

As described above, according to the second embodiment, when the task client 2 uses new data that does not exist in the flow information table, the data collection/delivery server 1 first registers the name of the new data as the data name 261 of the use count table 260 in association with the task specifying information. Then, when the use count of the data name 261 becomes the predetermined threshold or more in the same task specifying information, the data collection/delivery server 1 adds the data name 261 to one of the flow information tables F001 to F003.

As described above, even when the data to be used that does not exist in one of the flow information tables F001 to F003 is newly added, the new data to be used is not added to the flow information table until the use count of the new data reaches the predetermined use count in the same task specifying information. In this manner, in a case where the task client 2 acquires the information of the flow information table from the data collection/delivery server 1 to execute the task, even when new data to be used is added, addition of the data to be used to one of the flow information tables F001 to F003 is put on hold until the use count of the data to be used becomes the threshold or more. Then, only after the use count of the new data to be used becomes the predetermined threshold or more in the same task, the data to be used is added to one of the flow information tables F001 to F003. With this, it is possible to prevent temporarily-used data to be used or hardly-used data to be used from being added to one of the flow information tables F001 to F003.

It should be noted that in the same manner as in the first embodiment, the relevance table 250 and the relevant information management table 230 for defining data to be used in the task corresponding to the task specifying information may be defined in combination as the association information. In the second embodiment, when at least one of data to be used in a task managed by the association information is the same in pieces of task specifying information, it is determined that those pieces of task specifying information are relevant to each other.

### Third Embodiment

FIG. 25 to FIG. 27 are illustrations of a third embodiment of this invention. In the second embodiment, an example is described in which when new data to be used is added in a specific task indicated by the task specifying information, the new data to be used is added to the flow information table after the new data to be used has been used in the specific task for the predetermined number of times. In the third embodiment, an example is described in which when new data to be used is added in a specific task indicated by the task specifying information, the task client 2 is notified of the fact that the data to be used is added.

FIG. 25 is a flowchart for illustrating an example of processing to be executed by the relevant information processing module 130. This processing is obtained by changing a part of the processing (S25A) illustrated in FIG. 23B according to the second embodiment (S25B), that is, by adding Step S2521 and Step S2522 after Step S252 of FIG. 23B. Other parts of the configuration of the third embodiment are the same as in the second embodiment.

In FIG. 25, when the record to be retrieved is found in the use count table 260 (new data name 261), the relevant information processing module 130 proceeds to Step S2521. When no record to be retrieved is found, the relevant information processing module 130 proceeds to Step S2522.

In Step S2521, the data collection/delivery server 1 delivers information of a record of the flow information table relevant to the new data name 261, data to be used in the record, and a record of the use count table 260 satisfying the search condition to the task client 2.

On the other hand, in Step S2522, because there is no corresponding record in the use count table 260, the data collection/delivery server 1 delivers information of the record of the flow information table and data to be used in the record to the task client 2.

It should be noted that other steps are the same as in FIG. 23B of the second embodiment, and hence a description thereof is omitted.

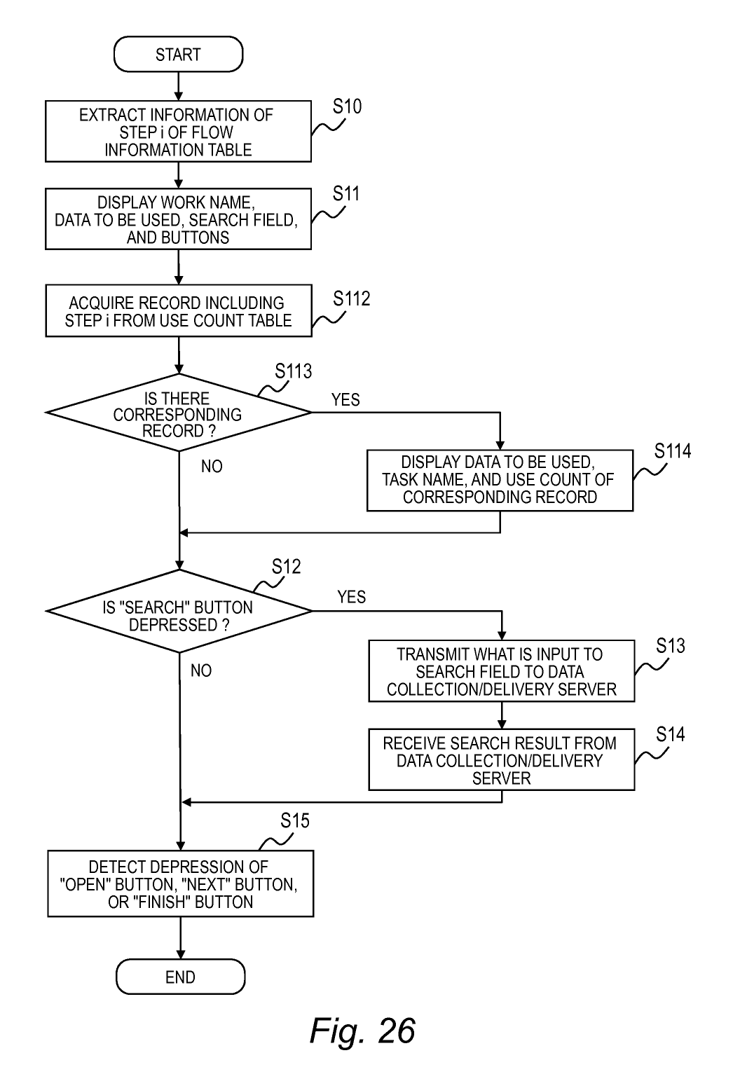

FIG. 26 is a flowchart for illustrating an example of processing to be executed by the screen display module 22 of the task client 2. This processing is obtained by inserting Step S112, Step S113, and Step S114 between Step S11 and Step S12 of the flowchart of the first embodiment of FIG. 13, and other parts of the configuration are the same as in FIG. 13 of the first embodiment.

In Step S10 and Step S11, in the same manner as in FIG. 13 of the first embodiment, the screen display module 22 of the task client 2 acquires, from the flow information table, the data to be used, the value of the data to be used, and the like relating to the current step i. Then, the screen display module 22 generates, based on the acquired information of the flow information table, the display elements including the work name 222 and the data to be used 223 corresponding to the current step ID 221 and the search field (input field) 404 and the “search” button 402 that are to be displayed on the input/output apparatus 24, and outputs the generated display elements to the input/output apparatus 24 (S11).

Next, the screen display module 22 acquires from the use count table 260 the information of the record corresponding to the step i to be currently displayed. The screen display module 22 determines whether or not there is a record corresponding to the step i (S113). When there is a corresponding record, the screen display module 22 proceeds to Step S114, and outputs from the corresponding record of the use count table 260 the data name 261, the task name 263, and the use count 265 to the input/output apparatus 24.

It should be noted that the processing after Step S114 is the same as in FIG. 13 of the first embodiment, and hence a description thereof is omitted.

Through the processing described above, it is possible to display on the input/output apparatus 24 the information of the record of the flow information table and the information of the record of the use count table 260 corresponding to the step ID of the record.

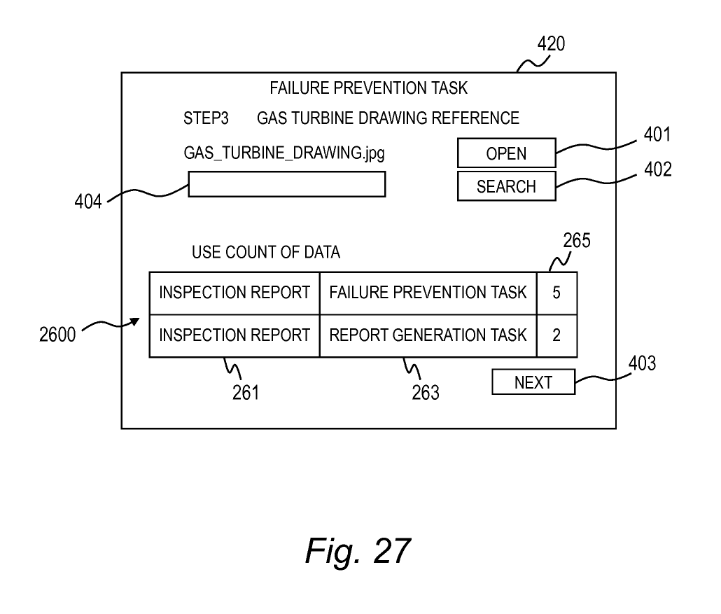

FIG. 27 is an image for illustrating an example of a screen to be output on the input/output apparatus 24 of the task client 2 executing the failure prevention task. Through the processing of FIG. 26 described above, such a screen 420 illustrated in FIG. 27 is displayed on the output unit of the input/output apparatus 24. This screen 420 is displayed when the step ID is “003” and the work name 222 of the failure prevention task is “gas turbine drawing reference”, and the buttons 401 to 403 and the search field 404 are the same as in FIG. 10 of the first embodiment. In the third embodiment, the screen 420 includes an area 2600 for displaying a part of the records of the use count table 260, and the data name 261, the task name 263, and the use count 265 are displayed in the area 2600.

With this, the user executing the failure prevention task on the task client 2 can know, in addition to the need to refer to the gas turbine drawing, the need to use the inspection report also in the report generation task in the step ID “003” of the same failure prevention task.

As described above, by the screen display module 22 adding the information of the use count table 260 to the screen for outputting details of each step (record) of the flow information table, it is possible to present the fact that data used in the different task executed by another user is data that can also be used in the current task.

### Fourth Embodiment

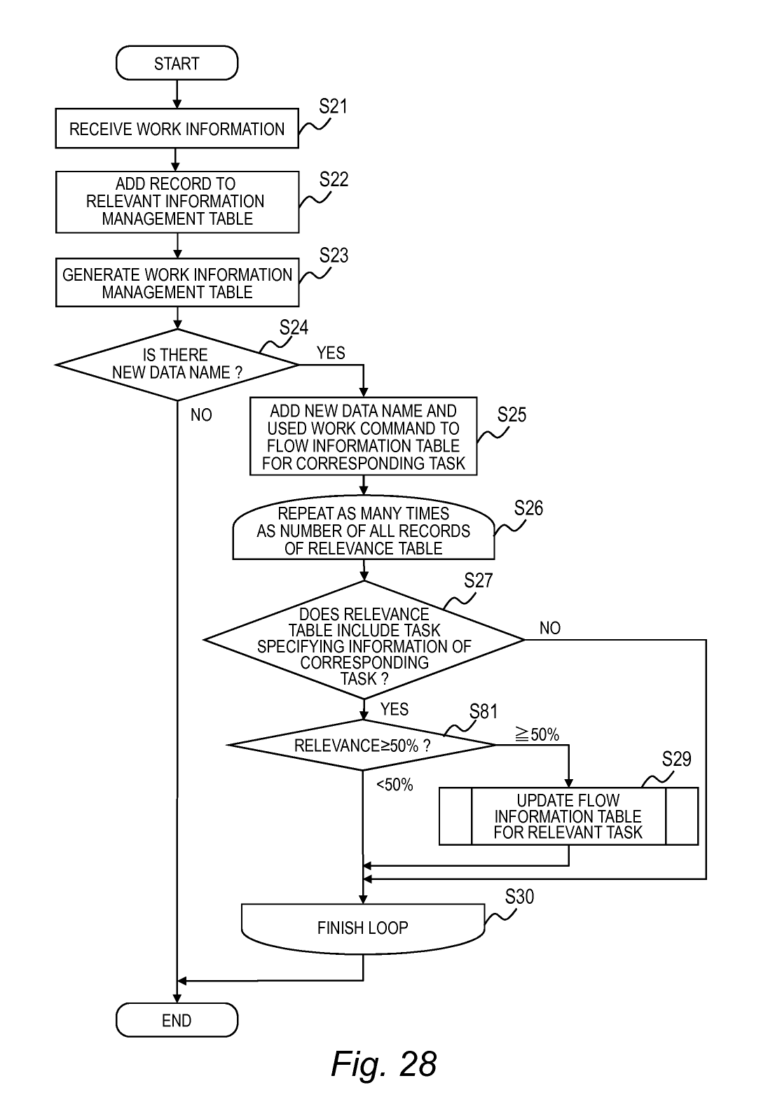

FIG. 28 to FIG. 31 are illustrations of a fourth embodiment of this invention. In the first embodiment, an example is described in which when data used in one task is perfectly the same as data used in another task, those tasks are relevant to each other, and the relevance is indicated by a binary value. In the fourth embodiment, an example is described in which even when data used in one task is partially the same as data used in another task, the relevance is calculated to be converted into a numerical value. Further, an example is described in which the relevance between the tasks is determined based on a threshold of the relevance converted into a numerical value.

FIG. 28 is a flowchart for illustrating an example of processing to be executed by the relevant information processing module 130. This flowchart is obtained by replacing Step S28 with Step S81 among the steps of the processing of FIG. 15 of the first embodiment, and other parts of the processing are the same as in FIG. 15 of the first embodiment.

In Step S81, when the relevance 253 of the record of the relevance table 250 including the task specifying information for which the currently new data name is added to the data to be used 223 of the flow information table is 50% or more, which is a predetermined threshold, the relevant information processing module 130 proceeds to Step S29, and adds a record to the flow information table for the relevant task. Other parts of the processing are the same as in FIG. 15 of the first embodiment, and hence a description thereof is omitted.

Though this processing, when new data to be used 223 is added in the flow information table F001, the same record as the record for the step ID added to the flow information table F001 is added to the flow information table F003 relevant to this flow information table F001.

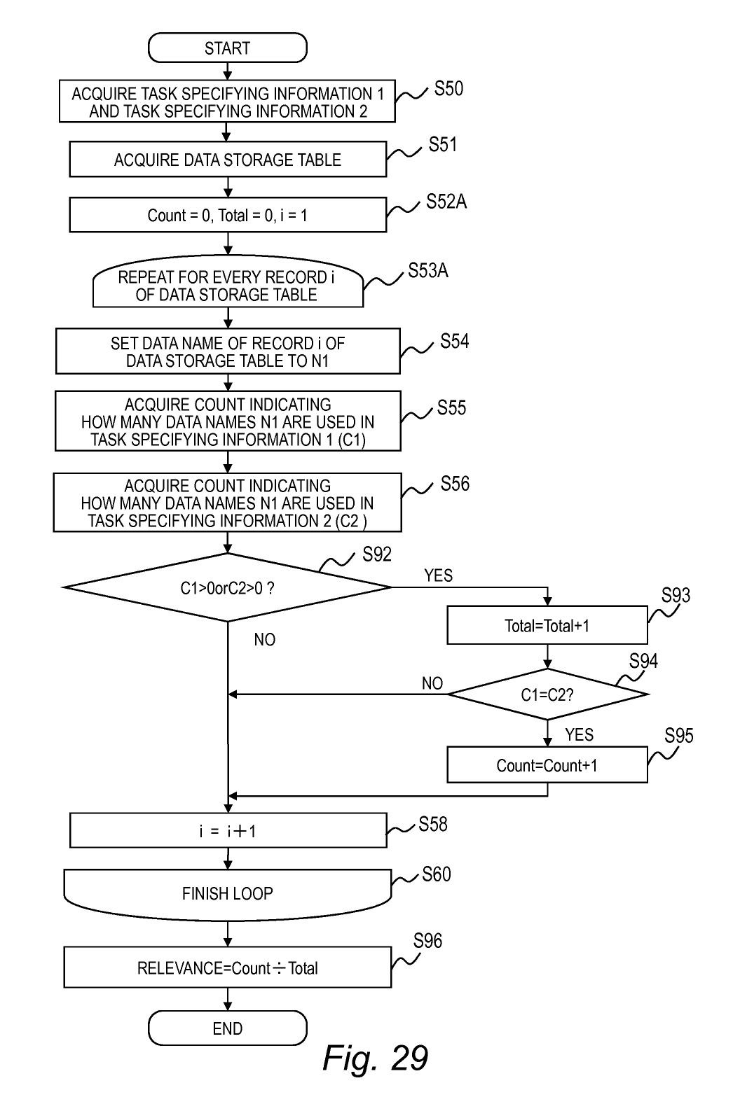

FIG. 29 is a flowchart for illustrating an example of processing to be executed by the relevance calculation module 140. In this flowchart, an example is illustrated in which the processing of FIG. 17 of the first embodiment is partially changed and the relevance is displayed in percentage.

This processing is processing executed in Step S48 of FIG. 16 of the first embodiment. The relevance is calculated for the record of the relevance table 250 selected in the loop of Step S26 to Step S30 of FIG. 15. In the fourth embodiment, an extent to which the data used in the flow information tables corresponding to a pair of the task specifying information 1 and the task specifying information 2 of the relevance table 250 match is calculated as the relevance, and the relevance 253 of the relevance table 250 is updated.

The relevance calculation module 140 reads the record of the relevance table 250 selected in the loop of Step S26 to Step S30 of FIG. 15, and acquires the task specifying information 1 (251) and the task specifying information 2 (252) of the relevance table 250 shown in FIG. 19 (S50). Further, the relevance calculation module 140 acquires the data storage table 210 (S51).

The relevance calculation module 140 resets a variable Count and a variable Total to 0, and resets the variable i to 1 (S52A).

The relevance calculation module 140 repeats the processing of Step S53A to Step S60 for every record of the data storage table 210.

The relevance calculation module 140 reads the data name 212 of the i-th record of the data storage table 210 acquired in Step S51 and assigns the read data name to the variable N1 (S54). When i=1, N1 is “sensor information”.

Next, the relevance calculation module 140 acquires a count indicating how many data names N1 acquired in Step S54 are used in the data to be used 223 of the flow information table of the task specifying information 1 (251), and assigns the acquired count to the variable C1 (S55). In the case of the flow information table F001, the use count of “sensor information” is 1.

Next, the relevance calculation module 140 acquires a count indicating how many data names N1 acquired in Step S54 are used in the data to be used 223 of the flow information table of the task specifying information 2 (252), and assigns the acquired count to the variable C2 (S56). Also in the case of the flow information table F003, the use count of “sensor information” is 1.

The relevance calculation module 140 determines whether or not at least one of the variables C1 and C2 is more than 0 (S92). When at least one of the variables C1 and C2 is more than 0, the relevance calculation module 140 proceeds to Step S90, and adds 1 to the variable Total (S93). Next, the relevance calculation module 140 determines whether or not the variables C1 and C2 are equal to each other (S94). When the variables C1 and C2 are equal to each other, the relevance calculation module 140 proceeds to Step S95, and adds 1 to the variable Count. It should be noted that when the determination of Step S92 or Step 94 results in “No”, the relevance calculation module 140 proceeds to Step S58 without performing any processing.

In Step S58, the relevance calculation module 140 adds 1 to the variable i, and proceeds to the processing for the next record of the relevance table 250.

In Step S60, when the processing has not been finished for every record of the data storage table 210, the relevance calculation module 140 resets the variables C1 and C2 to 0, and then returns to Step S53A to repeat the processing described above. On the other hand, when the processing has been finished for every record of the data storage table 210, the relevance calculation module 140 finishes the loop of Step S53A to Step S60, and proceeds to Step S96.

In Step S96, the relevance calculation module 140 calculates the relevance between the task specifying information 1 and the task specifying information 2 as follows:

Relevance=Count/Total

The relevance calculation module 140 then updates the relevance 253 of the relevance table 250. It should be noted that the relevance 253 may be output as a percentage.

Through the processing described above, the relevance calculation module 140 calculates, for every piece of data stored in the data storage table 210, the use counts of its data name in the flow information tables for both tasks of the task specifying information 1 and the task specifying information 2, determines a combination of pieces of task specifying information having at least one of the data names as relevant pieces of task specifying information, and calculates an extent to which the data names match among all data names as the relevance. With this, it is possible to identify a combination of tasks in which data to be used by a plurality of tasks is partially the same.

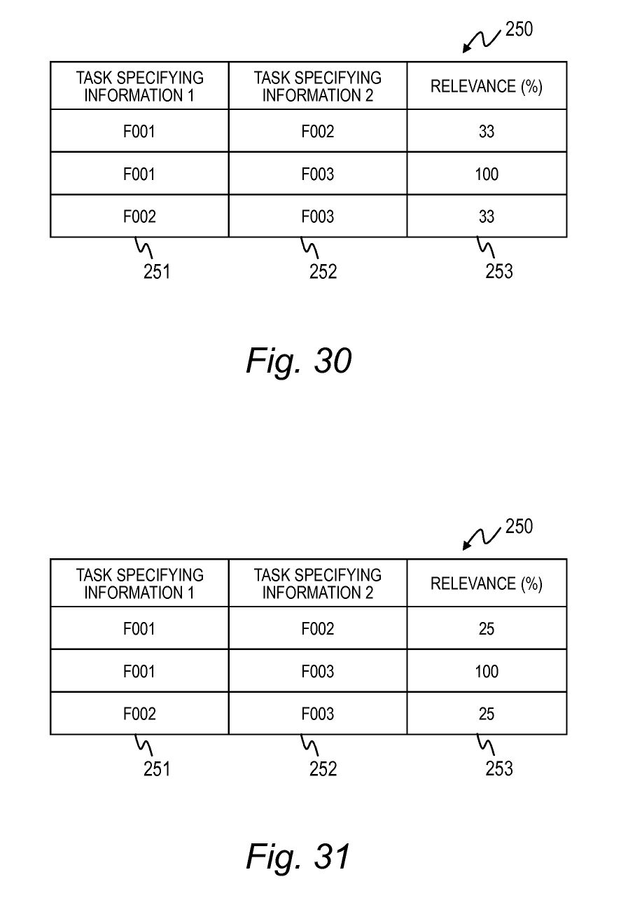

FIG. 30 and FIG. 31 are diagrams for showing examples of the relevance table 250. In FIG. 30, an example is shown in which the relevance 253 is calculated through the processing of the fourth embodiment when the flow information tables F001 to F003 are those shown in FIG. 3 to FIG. 5 of the first embodiment. The relevance 253 of a record having the relevance 253 of “irrelevant” in the first embodiment is changed to 33%.

Next, in FIG. 31, an example is shown in which the relevance 253 is calculated through the processing of the fourth embodiment when a record having “inspection report” (step ID “003”) as the data to be used 223 is added to the flow information tables F001 and F003 as shown in FIG. 20 and FIG. 21 of the first embodiment. The relevance 253 of a record having the relevance 253 of “irrelevant” in the first embodiment is changed to 25%.

As described above, according to the fourth embodiment, an extent to which the data to be used 223 in different flow information tables match is output as a percentage and the percentage is set as the relevance 253, and it is thus possible to understand the relevance between the tasks corresponding to the flow information tables as a numeral value.

### Fifth Embodiment

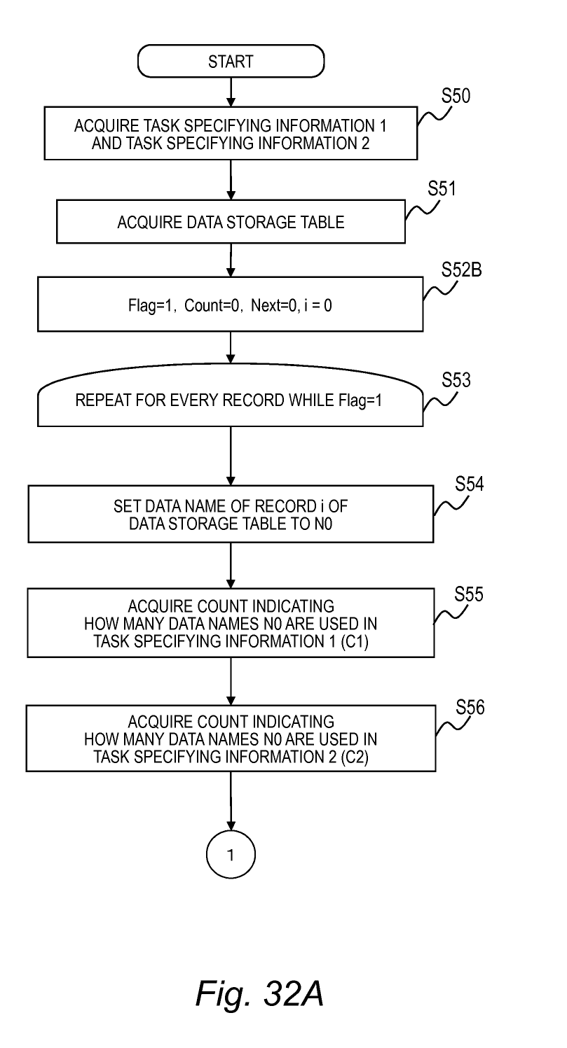

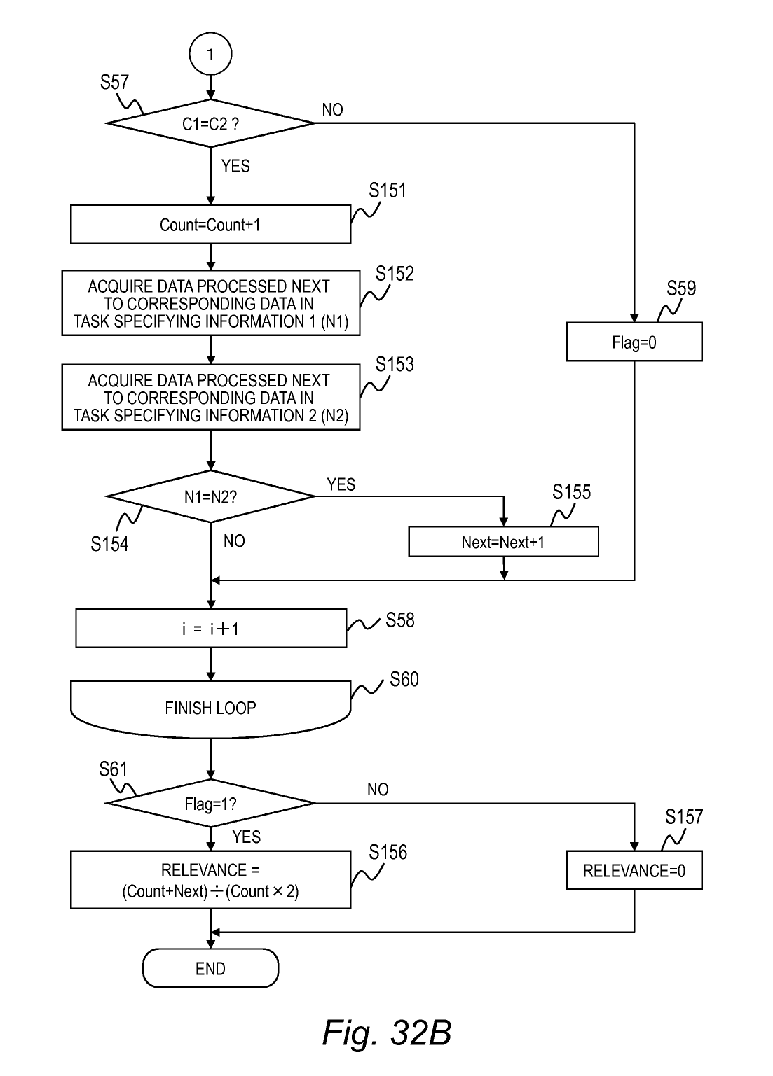

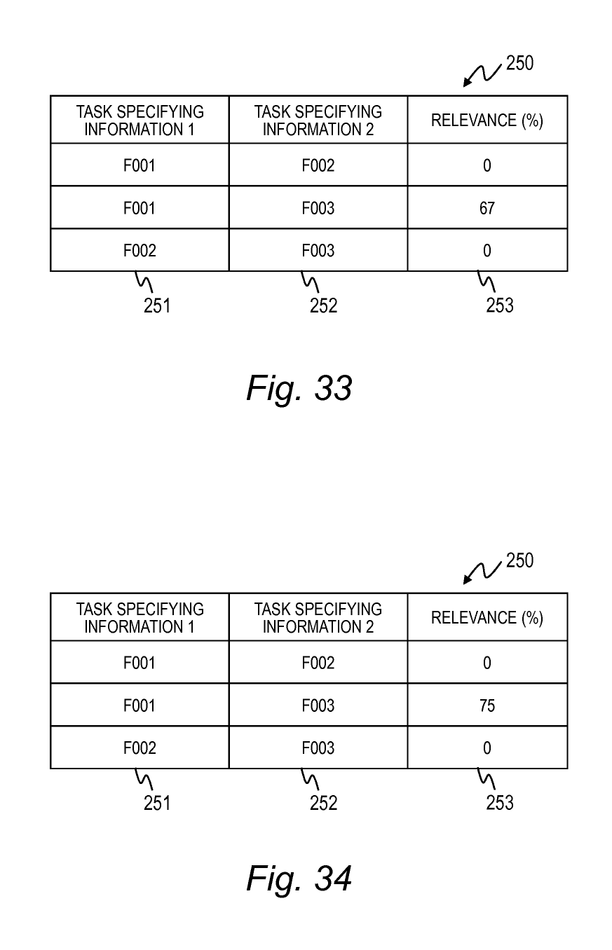

FIG. 32A, FIG. 32B, FIG. 33, and FIG. 34 are illustrations of a fifth embodiment of this invention. In the first embodiment, an example is described in which when the data to be used 223 in different flow information tables are the same, the relevance 253 is output as a binary value, namely, “relevant”. In the fifth embodiment, an example is described in which the relevance is calculated as a numerical value in consideration of an order in which the data to be used 223 are arranged. It should be noted that in the fifth embodiment, FIG. 28 of the fourth embodiment is used, and the relevant flow information table is updated when the relevance 253 is a threshold (50%) or more. Other parts of the configuration are the same as in the first embodiment.

FIG. 32A and FIG. 32B are flowcharts illustrating an example of processing to be executed by the relevance calculation module 140. In this flowchart, an example is illustrated in which the processing of FIG. 17 of the first embodiment is partially changed and the relevance calculation module 140 calculates the relevance as a numerical value in consideration of the order in which the data to be used 223 are arranged in the flow information table.

This processing is processing executed in Step S48 of FIG. 16 of the first embodiment. The relevance is calculated for the record of the relevance table 250 selected in the loop of Step S26 to Step S30 of FIG. 15. In the fifth embodiment, when the data to be used 223 used in the flow information tables corresponding to a pair of the task specifying information 1 and the task specifying information 2 of the relevance table 250 match, the relevance is calculated by adding 1 to the variable Count, and the relevance 253 of the relevance table 250 is updated. Then, when calculating the relevance 253, the relevance calculation module 140 considers the order in which the data to be used 223 are arranged in the flow information table. This point is a difference from the first embodiment.

The relevance calculation module 140 reads the record of the relevance table 250 selected in the loop of Step S26 to Step S30 of FIG. 15, and acquires the task specifying information 1 (251) and the task specifying information 2 (252) of the relevance table 250 shown in FIG. 19 (S50). Further, the relevance calculation module 140 acquires the data storage table 210 (S51).

The relevance calculation module 140 resets the variable Flag and the variable i to 1, and resets the variable Count, the variable Total, and the variable i to 0 (S52B).

The relevance calculation module 140 repeats the processing of Step S53 to Step S60 for every record of the data storage table 210 while Flag is 1.

The relevance calculation module 140 reads the data name 212 of the i-th record of the data storage table 210 acquired in Step S51 and assigns the read data name to a variable NO (S54). When i=1, NO is “sensor information”.

Next, the relevance calculation module 140 acquires a count indicating how many data names NO acquired in Step S54 are used in the data to be used 223 of the flow information table of the task specifying information 1 (251), and assigns the acquired count to the variable C1 (S55). In the case of the flow information table F001, the use count of “sensor information” is 1, which is counted for the step ID “001”.

Next, the relevance calculation module 140 acquires a count indicating how many data names NO acquired in Step S54 are used in the data to be used 223 of the flow information table of the task specifying information 2 (252), and assigns the acquired count to the variable C2 (S56). In the case of the flow information table F003, the use count of “sensor information” is 1, which is counted for the step ID “003”.

In Step S57 of FIG. 32, the relevance calculation module 140 determines whether or not the variables C1 and C2 are equal to each other (S57). When the variables C1 and C2 are equal to each other, the relevance calculation module 140 proceeds to Step S151 while maintaining Flag to 1. When the variables C1 and C2 are not equal to each other, the relevance calculation module 140 proceeds to Step S59, and updates Flag to 0.

In Step S151, the relevance calculation module 140 adds 1 to the variable Count. Then, in Step S152, the relevance calculation module 140 acquires, from the flow information table corresponding to the task specifying information 1, the name of the data to be used 223 of the record next to the current record of interest, and assigns the acquired name to the variable N1. In FIG. 3, when the current record of interest is “sensor information” of the step ID “001” of the flow information table F001, the data to be used 223 “facility photograph” of the next record is assigned to the variable N1.

In Step S153, the relevance calculation module 140 acquires, from the flow information table corresponding to the task specifying information 2, the name of the data to be used 223 of the record next to the current record of interest, and assigns the acquired name to the variable N2. In FIG. 5, when the current record of interest is “sensor information” of the step ID “002” of the flow information table F003, the data to be used 223 “gas turbine drawing” of the next record is assigned to the variable N2.

Next, in Step S154, the relevance calculation module 140 determines whether or not the variable N1 and the variable N2 are equal to each other. When the variable N1 and the variable N2 are equal to each other, the relevance calculation module 140 proceeds to Step S155, and adds 1 to a variable Next.

Next, in Step S58, the relevance calculation module 140 adds 1 to the variable i, and proceeds to the processing for the next record of the relevance table 250.

In Step S60, when Flag is 1, and when the processing has not been finished for every record of the data storage table 210, the relevance calculation module 140 resets the variables C1 and C2 to 0, and then returns to Step S53 to repeat the processing described above. On the other hand, when Flag is 0, or when the processing has been finished for every record of the data storage table 210, the relevance calculation module 140 finishes the loop of Step S53 to Step S60, and proceeds to Step S61.

In Step S61, the relevance calculation module 140 determines whether or not Flag is 1. When Flag is 1, the relevance calculation module 140 proceeds to Step S156, and when Flag is not 1, the relevance calculation module 140 proceeds to Step S157.

In Step S156, the relevance calculation module 140 calculates the relevance between the task specifying information 1 and the task specifying information 2 as follows:

Relevance=(Count+Next)/(Count×2)

The relevance calculation module 140 then updates the relevance 253 of the relevance table 250. It should be noted that the relevance 253 may be output as a percentage.

Through the processing described above, the relevance calculation module 140 calculates, for every piece of data stored in the data storage table 210, the use counts of its data name in the flow information tables for both tasks of the task specifying information 1 and the task specifying information 2, and adds 1 to the variable Count when the use counts are the same among all of the data names. Further, in a case where the data to be used 223 of the tasks of the task specifying information 1 and the task specifying information 2 are the same, the relevance calculation module 140 adds 1 to the variable Next when the data to be used 223 of the next record is also the same in both of the tasks. Then, the relevance calculation module 140 calculates the relevance based on the variable Count and the variable Next to update the relevance 253 of the relevance table 250.

Through the processing described above, when the data name 212 stored in the data storage table 210 is the same in the data to be used 223 of the flow information tables for both tasks of the task specifying information 1 and the task specifying information 2, the relevance calculation module 140 calculates the relevance 253 in consideration of whether or not the data name 212 is the same also in the next data to be used 223 of the flow information table. With this, it is possible to compare the relevance between the tasks through the use of the relevance 253 calculated in consideration of the order in which the data are arranged, in addition to an extent to which the data used in the flow information tables for the task specifying information 1 and the task specifying information 2 match.

FIG. 33 and FIG. 34 are diagrams for showing examples of the relevance table 250. In FIG. 33, an example is shown in which the relevance 253 is calculated through the processing of the fifth embodiment when the flow information tables F001 to F003 are those shown in FIG. 3 to FIG. 5 of the first embodiment. The relevance 253 of a record having the relevance 253 of “relevant” in the first embodiment is changed to 67%.

Next, in FIG. 34, an example is shown in which the relevance 253 is calculated through the processing of the fifth embodiment when the record having “inspection report” (step ID “003”) as the data to be used 223 is added to the flow information tables F001 and F003 in the same manner as in FIG. 20 and FIG. 21 of the first embodiment. The relevance 253 of a record having the relevance 253 of “relevant” in the first embodiment is changed to 75%, and it can be understood that the order in which the data names are arranged is also taken into consideration.

As described above, according to the fifth embodiment, when an extent to which the data to be used 223 in different flow information tables match is calculated, it is determined whether or not the next data to be used 223 is also the same. In this manner, it is possible to calculate a more precise relevance 253 in consideration of the order in which data corresponding to the data to be used 223 are arranged. With this, it is possible to identify another task in which the same data to be used 223 is used, and it is also possible to identify another highly relevant task easily based on the order of processing.

It should be noted that although in the fifth embodiment, in the same manner as the first embodiment, the variable Count is set depending on whether or not the data used in the flow information tables for the task specifying information 1 and the task specifying information 2 are the same, the order in which the data are arranged may be taken into consideration in the same manner as in the fifth embodiment after an extent to which the data used in the flow information table match is calculated in the same manner as in the fourth embodiment.

<Supplement>

In the first embodiment to the fifth embodiment, an example is described in which the flow information table is used for the calculation of the relevance 253 through the comparison of data processed by the task client 2. However, the use of a table is merely one embodiment, and how to realize this invention is not limited to the use of a table. For example, in place of tables, a log file of one task client 2 and a log file of another task client 2 may be compared with each other by the data collection/delivery server 1 to calculate the relevance 253.

Further, although FIG. 22 is an illustration of delivery of data in response to a request made by the task client 2 (pull delivery), this pull delivery is merely one embodiment, and the delivery of data may be realized by push delivery from the data collection/delivery server 1. Specifically, a mode can be adopted in which the task is determined to be executed regularly (e.g., once a month) and data is delivered automatically from the data collection/delivery server 1 to the task client 2 at the time of execution of the task.

Further, although an example is described in which this invention is applied to the computer system configured to execute the maintenance of the gas turbine in the first embodiment to the fifth embodiment, this invention is not limited to this example. For example, this invention is applicable to any computer system in which different tasks (task programs) are executed by the task clients 2 and the data and task used in the task clients 2 are held by a management computer (data collection/delivery server 1). It should be noted that the data used by the task client 2 only needs to be stored in an apparatus accessible to the management computer.

The computers, processing units, and processing means described related to this invention may be, for a part or all of them, implemented by dedicated hardware.

The variety of software exemplified in the embodiments can be stored in various media (for example, non-transitory storage media), such as electro-magnetic media, electronic media, and optical media and can be downloaded to a computer through communication network such as the Internet.

This invention is not limited to the foregoing embodiments but includes various modifications. For example, the foregoing embodiments have been provided to explain this invention to be easily understood; they are not limited to the configurations including all the described elements.

1. A computer, comprising:
a control unit comprising a processor; and
a storage unit configured to store data used by a plurality of tasks,
the computer being configured to calculate relevance between the plurality of tasks,
the storage unit being configured to hold:
data specifying information for specifying data used by the plurality of tasks;
task specifying information for specifying each of the plurality of tasks; and
association information for storing an association between the data specifying information to be used by each of the plurality of tasks and the task specifying information,
the control unit being configured to refer to the association information to output, as a combination of relevant pieces of task specifying information, different pieces of task specifying information that are associated with pieces of data specifying information specifying the data to be used by each of the plurality of tasks, at least one of the pieces of data specifying information being the same in the different pieces of task specifying information.

2. The computer according to claim 1, wherein the control unit is configured to refer to the association information to output, as the combination of relevant pieces of task specifying information, different pieces of task specifying information that are associated with pieces of data specifying information specifying the data to be used by each of the plurality of tasks, all of the pieces of data specifying information being the same in the different pieces of task specifying information.

3. The computer according to claim 1, wherein the control unit is configured to refer to the association information to calculate relevance based on a ratio of at least one same piece of data specifying information to the pieces of data specifying information specifying the data to be used by each of the plurality of tasks, and output the calculated relevance as relevance between the different pieces of task specifying information.

4. The computer according to claim 3, wherein the control unit is configured to determine the combination of the different pieces of task specifying information as the relevant pieces of task specifying information when the relevance is a predetermined threshold or more.

5. The computer according to claim 2,
wherein the storage unit is configured to hold:
data specifying information for specifying data used by the plurality of tasks;
task specifying information for specifying each of the plurality of tasks; and
association information for storing an association between an order of pieces of data specifying information to be used by each of the plurality of tasks and the task specifying information, and
wherein the control unit is configured to refer to the association information to calculate the relevance between different pieces of task specifying information that are associated with pieces of data specifying information specifying the data to be used by each of the plurality of tasks, the order of at least one of the piece of data specifying information being the same in the different pieces of task specifying information, based on a ratio of the at least one of the piece of data specifying information to the pieces of data specifying information.

6. The computer according to claim 1, wherein the control unit is configured to add, in a case where the combination of the different pieces of task specifying information is relevant pieces of task specifying information, when processing is added to a task corresponding to one of the pieces of task specifying information, the processing to another task corresponding to another of the pieces of task specifying information.

7. The computer according to claim 1, wherein the control unit is configured to add, in a case where the combination of the different pieces of task specifying information is relevant pieces of task specifying information, when processing is added to a task corresponding to one of the pieces of task specifying information and when a use count indicating how many times the processing has been used becomes a predetermined value or more after the use count is calculated, the processing to another task corresponding to another of the pieces of task specifying information.

8. The computer according to claim 1, wherein the control unit is configured to:
calculate, in a case where the combination of the different pieces of task specifying information is relevant pieces of task specifying information, when processing is added to a task corresponding to one of the pieces of task specifying information, a use count indicating how many times the processing has been used; and
notify another task corresponding to another of the pieces of task specifying information of the added processing, the task corresponding to one of the pieces of task specifying information, and the use count of the processing.

9. A relevance calculation method to be performed by a computer comprising a processor and a storage unit, for calculating relevance between a plurality of tasks, the relevance calculation method comprising:
a first step of storing, by the computer, data used by the plurality of tasks in the storage unit;
a second step of holding, by the computer, in the storage unit, data specifying information for specifying data used by the plurality of tasks, task specifying information for specifying each of the plurality of tasks, and association information for storing an association between the data specifying information to be used by each of the plurality of tasks and the task specifying information; and
a third step of referring, by the computer, to the association information to output, as a combination of relevant pieces of task specifying information, different pieces of task specifying information that are associated with pieces of data specifying information specifying the data to be used by each of the plurality of tasks, at least one of the pieces of data specifying information being the same in the different pieces of task specifying information.

10. The relevance calculation method according to claim 9, wherein the third step comprises referring, by the computer, to the association information to output, as the combination of relevant pieces of task specifying information, different pieces of task specifying information that are associated with pieces of data specifying information specifying the data to be used by each of the plurality of tasks, all of the pieces of data specifying information being the same in the different pieces of task specifying information.

11. The relevance calculation method according to claim 9, wherein the third step comprises referring, by the computer, to the association information to calculate relevance based on a ratio of at least one same piece of data specifying information to the pieces of data specifying information specifying the data to be used by each of the plurality of tasks, and output the calculated relevance as relevance between the different pieces of task specifying information.

12. The relevance calculation method according to claim 11, wherein the third step further comprises determining the combination of the different pieces of task specifying information as the relevant pieces of task specifying information when the relevance is a predetermined threshold or more.

13. The relevance calculation method according to claim 10,
wherein the second step comprises holding, by the computer, in the storage unit:
task specifying information for specifying each of the plurality of tasks; and
association information for storing an association between an order of pieces of data specifying information to be used by each of the plurality of tasks and the task specifying information, and
wherein the third step comprises referring to the association information to calculate the relevance between different pieces of task specifying information that are associated with pieces of data specifying information specifying the data to be used by each of the plurality of tasks, the order of at least one of the pieces of data specifying information being the same in the different pieces of task specifying information, based on a ratio of the at least one of the pieces of data specifying information to the pieces of data specifying information.

14. The relevance calculation method according to claim 9, further comprising adding, by the computer, in a case where the combination of the different pieces of task specifying information is relevant pieces of task specifying information, when processing is added to a task corresponding to one of the pieces of task specifying information, the processing to another task corresponding to another of the pieces of task specifying information.

15. The relevance calculation method according to claim 9, further comprising adding, by the computer, in a case where the combination of the different pieces of task specifying information is relevant pieces of task specifying information, when processing is added to a task corresponding to one of the pieces of task specifying information and when a use count indicating how many times the processing has been used becomes a predetermined value or more after the use count is calculated, the processing to another task corresponding to another of the pieces of task specifying information.

16. The relevance calculation method according to claim 9, further comprising:
calculating, by the computer, in a case where the combination of the different pieces of task specifying information is relevant pieces of task specifying information, when processing is added to a task corresponding to one of the pieces of task specifying information, a use count indicating how many times the processing has been used; and
notifying, by the computer, another task corresponding to another of the pieces of task specifying information of the added processing, the task corresponding to one of the pieces of task specifying information, and the use count of the processing.

17. A non-transitory computer readable storage medium having stored thereon a program for calculating relevance between a plurality of tasks by a computer comprising a processor and a storage unit, the program controlling the computer to execute:
a first step of storing data used by the plurality of tasks in the storage unit;
a second step of holding, in the storage unit, data specifying information for specifying data used by the plurality of tasks, task specifying information for specifying each of the plurality of tasks, and association information for storing an association between the data specifying information to be used by each of the plurality of tasks and the task specifying information; and
a third step of referring to the association information to output, as a combination of relevant pieces of task specifying information, different pieces of task specifying information that are associated with pieces of data specifying information specifying the data to be used by each of the plurality of tasks, at least one of the pieces of data specifying information being the same in the different pieces of task specifying information.

18. The non-transitory computer readable storage medium according to claim 17, wherein the third step comprises referring to the association information to output, as the combination of relevant pieces of task specifying information, different pieces of task specifying information that are associated with pieces of data specifying information specifying the data to be used by each of the plurality of tasks, all of the pieces of data specifying information being the same in the different pieces of task specifying information.

19. The non-transitory computer readable storage medium according to claim 17, wherein the third step comprises referring to the association information to calculate relevance based on a ratio of at least one same piece of data specifying information to the pieces of data specifying information specifying the data to be used by each of the plurality of tasks, and output the calculated relevance as relevance between the different pieces of task specifying information.

20. The storage medium according to claim 19, wherein the third step further comprises determining the combination of the different pieces of task specifying information as the relevant pieces of task specifying information when the relevance is a predetermined threshold or more.
